(19) United States
(12) Patent Application Publication
(10) Pub. No.: US 2026/0244821 A1
(43) Pub. Date: Aug. 20, 2026

(54) METHOD AND SYSTEM FOR DIGITALLY REPLICATING REAL-WORLD INFRASTRUCTURES

(71) Applicant: Huawei Technologies Co., Ltd., Shenzhen (CN)

(72) Inventors: Remziye Irem Bor Yaliniz, Ottawa (CA); Hang Zhang, Ottawa (CA); Nimal Gamini Senarath, Ottawa (CA)

(21) Appl. No.: 19/577,772

(22) Filed: Mar. 25, 2026

Related U.S. Application Data
(63) Continuation of application No. PCT/CN2024/091224, filed on May 6, 2024.
(60) Provisional application No. 63/586,574, filed on Sep. 29, 2023.

(51) Int. Cl. G06F 30/20; G06F 30/13

(52) U.S. Cl. CPC G06F 30/20; G06F 30/13

(57) ABSTRACT

A method and a system of digitally replicating real-world infrastructures for simulating behaviors of real-world objects is provided. The method includes instantiating one or more digital representative (D-Rep) instances corresponding to digital replicas of the real-world objects included in the real-world infrastructure to form a digital infrastructure (D-Inf). The method further includes providing a communication plane adapted for providing services to the D-Inf. The method further includes connecting to the real-world objects using the communication plane to collect real-world data defining a state of the real-world objects and associating the real-world data to the D-Rep instances, and simulating a behavior of the real-world objects via the D-Rep instances using a simulator accessible to the D-Inf instance using the communication plane.

### CROSS-REFERENCE TO RELATED APPLICATIONS

This application is a continuation of International Patent Application No. PCT/CN2024/091224, filed on May 06, 2024, which claims the benefits of U.S. Provisional Application No. 63/586,574, filed on September 29, 2023, the disclosures of which are hereby incorporated by reference in their entireties.

### TECHNICAL FIELD

The technical field generally relates to digital representation of real-world entities, and more specifically to a method and system for generating and managing a digital replicate of a real-world infrastructure for simulation purposes.

### BACKGROUND

As the real world becomes more and more digitized and controlled or monitored with the help of the digital world, and as precise control over real-world systems increases, digital twins have been created to provide digital representations of real-world entities, allowing manipulations and simulations of a real-world entity through its digital-world counterpart. Those digital twins can represent any type of system, such as engines, ports and factories. Usually, the digital twins are generated for specific applications, such as operative simulations for control purposes, and are therefore stored on local networks inaccessible from outside nodes. Other Digital Twins solutions can be empowered with the support of cloud services. However, as the applications are specific, Digital Twins of real-world entities that may influence one another are usually incapable of communicating or exchanging data.

That causes inefficiencies in providing infrastructure services by causing duplications of data collection and analysis. Accordingly, scaling, standardization, accuracy, and efficiency of these services become bottlenecks.

Therefore, there is a need of a system and a method that can help in overcoming at least one of the limitations described above.

### SUMMARY

The proposed method and system provide a scalable digital world replicate of a real-world infrastructure, allowing for performing simulations and predictions based on digital representatives included in the digital world replicate, and helping in overcoming duplication of data found in siloed digital world applications. The proposed digital infrastructure, in an embodiment, is a module of a Digital World platform of wireless networks (NET4DW) that provides services to infrastructure D-Reps and D-Inf sub-platforms, and allows for large-scale simulations of a digital representation of a real-world infrastructure.

In one aspect, a method of digitally replicating real-world infrastructures for simulating behaviors of real-world objects is provided. The method includes instantiating a digital infrastructure (D-Inf) corresponding to at least one real-world infrastructure, including instantiating digital representatives (D-Reps) corresponding to digital replicas of the real-world objects included in the at least one real-world infrastructure. The method further includes providing a communication plane for providing services to the D-Inf, and connecting the D-Inf to the real-world objects using the communication plane to collect real-world data defining a state of the real-world objects, the D-Inf being connected to a real-world object via a respective D-Rep, the respective D-Rep being associated with the real-world data of the real-world object. The method also includes simulating a behavior of the real-world objects via the D-Reps using a simulator accessible to the D-Inf instance using the communication plane.

In some embodiments, providing a communication plane includes providing data exchange means, or protocol, between the D-Inf and its corresponding real-world infrastructure and between the D-Inf and an external D-Inf.

In some embodiments, providing the services to the D-Inf include providing a data collection service for collecting the real-world data from the real-world objects and for associating the real-world data collected to the corresponding D-Reps. Providing the services also includes providing a connection service for connecting to the real-world objects to the corresponding D-Reps, providing a hosting service for allocating data storage associated with the D-Reps, and providing an analysis service for managing one or more analysis task performed on the real-world data associated with the D-Reps. When the Control and Management (C/M) plane and Data plane are provided, each connects to the data collection service, the connection service, the hosting service, and the analysis service.

In some embodiments, providing the data collection service further includes monitoring battery life of sensors used to collect the real-world data from the real-world objects, adjusting pre-filtering settings of the real-world data collected based at least on the battery life of the sensors, and monitoring real-world objects for new real-world data available.

In some embodiments, providing the connection service further includes, connecting the D-Reps of the D-Inf to each other to allow interaction between the D-Reps, and connecting the D-Inf to external functions, external D-Reps or third-party services to allow for using external services.

In some embodiments, providing the connection service further includes migrating the D-Reps from one server to another within the data storage based on mobility of the real-world objects, setting-up connectivity tunnels for connection to external simulation environments, and authenticating the D-Reps.

In some embodiments, providing the hosting service further includes managing lifecycle of the D-Reps, including resource allocation and deallocation of the D-Reps, and managing associations within the D-Inf.

In some embodiment, providing the analysis service further includes determining connectivity requirements for performing the one or more analysis task, performing resource management for computation and storage requirements for performing the one or more analysis tasks, and providing access to libraries of the simulator.

In some embodiments, providing the services to the D-Inf further includes processing, with the data collection service, the real-world data collected from the real-world objects and associated with the corresponding D-Rep instances, managing, using the connection service, services from other elements of the D-Inf, managing, using the hosting service, privacy of the data storage selected for hosting the D-Rep instances, and analyzing, using the analysis service, the real-world data collected using the simulator.

In some embodiments, providing the data collection service further includes one or more of merging similar or non-urgent real-world data collected, cleaning or reducing size of the real-world data collected, discarding defective real-world data collected, sampling redundant real-world data collected, labeling and/or tunneling urgent real-world data collected, and processing urgent real-world data collected by edge nodes of the platform.

In some embodiments, providing the connection service further includes managing data collection missions and connection missions, and in-network processing of the data, including distribution of processing algorithms.

In some embodiments, providing the hosting service further includes selecting to instantiate the D-Inf and the D-Reps in a private or common data storage, validating D-Rep health and measuring overall accuracy of the D-Reps, managing anonymization and labelling of the real-world data collected and/or digital-world data prior to analysis, and selecting data storage location based on a location of the real-world objects.

In some embodiments, providing the analysis service further includes providing abstraction levels for the D-Reps, labelling the real-world data collected and digital-world data, anonymizing the real-world data collected, and selecting and providing benchmark libraries to the simulator.

In some embodiments, providing the hosting service further includes selecting to instantiate the D-Inf and the D-Reps in a private or common data storage and selecting the data storage location based on a location of the real-world objects.

In some embodiments, the method further includes providing interconnection interfaces for connecting together the data collection service, the connection service, the hosting service and the analysis service. Further, the method may include providing additional interfaces for connecting the D-Inf to gateways for accessing third-party resources, or providing additional interfaces for connecting the D-Reps to D-X boxes, wherein a D-X boxes is an additional D-Inf.

In a second aspect, an apparatus for digitally replicating real-world infrastructures for simulation purposes is provided. The apparatus may perform any method described herein. In some embodiments, the apparatus includes a digital infrastructure (D-Inf) module adapted to instantiate a D-Inf corresponding to a real-world infrastructure. The apparatus also includes a digital representation (D-Rep) module adapted to instantiate one or more D-Rep corresponding to digital replicas of real-world objects included in the real-world infrastructure. The apparatus further includes a communication plane adapted to provide services to the D-Inf, and a simulator accessible to the D-Inf instance via at least some of the C/M and data services, for simulating the behavior of the real-world objects via the D-Rep instances.

In some embodiments, the communication plane of the apparatus includes a Control and Management (C/M) plane bus for providing C/M services to the D-Reps instances, and a Data plane bus for providing data services to the D-Rep instances.

In some embodiments, the apparatus further includes a data collection module adapted to collect the real-world data from the real-world objects and to associate the real-world data collected to the corresponding D-Reps, a connection module adapted to connect to the real-world objects to the corresponding D-Reps, a hosting module adapted to allocate data storage associated with the D-Reps, and an analysis module adapted to manage one or more analysis task to perform on the D-Rep instances via the simulator.

In another aspect, an apparatus comprising one or more processors and memory storing instructions which, when executed by the one or more processors, configures the apparatus to perform any method described herein is provided.

In another aspect, an apparatus comprising a processing unit is provided. The processing unit is configured to execute any method described herein.

In another aspect, a computer-readable medium is provided. The medium includes computer-readable instructions stored thereon that, when executed by one or more processors, perform any method described herein.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment.

FIG. 1 is a schematic view of a Digital World platform of wireless networks including a digital infrastructure platform according to an embodiment.

FIG. 2 is a schematic view of the function environment provided by a digital infrastructure according to an embodiment.

FIG. 3 is a schematic view of a digital infrastructure including interfaces, according to an embodiment.

FIG. 4 is a schematic view of internal data interfaces within the system of FIG. 3 according to an embodiment.

FIG. 5 is a schematic view of exemplary digital infrastructure instances with associated data interfaces according to an embodiment.

FIG. 6 shows an example of a VUE generation/creation process flow according to an embodiment.

FIG. 7 shows an example communication system that can be used in conjunction with one or more embodiments.

FIG. 8 shows an example of the interconnections between base stations and other elements of a communication system.

FIG. 9 shows an example of an electronic device, a terrestrial base station, and a non-terrestrial base station of a communication system.

FIG. 10 shows a block diagram of an electronic device according to an embodiment.

FIG. 11 shows a 6G system conceptual structure according to an embodiment.

FIG. 12 shows a representation of function elements and internal interfaces of a connectivity service (NET4CON) according to an embodiment.

FIG. 13 shows example external interfaces of the NET4CON service of FIG. 12.

FIG. 14 shows additional example external interfaces of the NET4CON service of FIG. 12.

FIG. 15 shows a block diagram of an example system that may be used in conjunction with one or more embodiments.

### DETAILED DESCRIPTION OF THE ILLUSTRATIVE EMBODIMENTS

In the following description and figures, same reference numbers refer to similar elements of the present disclosure. Furthermore, to not unduly clutter the figures, it is possible that a figure may not contain all the reference numbers of the elements found in the figure. It is also possible that some elements or components may be referenced in only one figure. The element thereby referenced can easily be inferred in the other figures shown. The embodiments, geometrical configurations, materials and/or dimensions shown in the figures or described in the present disclosure are only indicative, and show possible embodiments, presented as examples, and should not be interpreted as limitations of the present disclosure.

In the following description, a digital representative (D-Rep) refers to a virtual replica, or digital twin, of physical objects or set of objects. D-Reps can correspond to replicas or digital representatives of physical devices, including vehicles such as cars and robots, provided with connectivity to the network and sensors. Other types of digital entities include digital infra-structures (D-Inf) or digital networks (D-Net). The D-Rep digitally mimics its associated real-world entity for practical purposes such as simulation and testing, for example. For instance, the real-world entity can transmit entity data to the D-Rep such that the D-Rep can maintain a similar state as its real-world counterpart. For example, the data can include sensor data, logical state, and input/output values. Since the D-Rep is a digital equivalent to its associated real-world entity, a behavior of the real-world entity, current or expected, can be accurately simulated by performing simulations with the D-Rep. Therefore, D-Reps can be useful in a number of application areas. Further, a D-Rep may be generated to represent real-world entities having different abstraction levels. In the area of communications, abstraction levels can be split into a communication region, a cellphone, a base station (BS), an antenna, or a chip in the radio-frequency (RF) chain, for example. A given D-Rep abstraction level can be determined based on the application, prediction/simulation goals, available data, available analytical or computational resources, for example.

A digital infrastructure (D-Inf), in the present disclosure, refers to a digital replica of a real-world infrastructure that includes a collection of real-world objects having a relative degree of cooperation and/or integration. For example, the real-world entities can include, without being limited to, buildings, roads, robots, factories, railways, cars, wireless network equipment and resources each having an associated D-Rep, and the D-Inf can be a collection of all those D-Rep. For example, the D-Inf can be a digital representative of a city encompassing all those real-world entities. It should be noted that in some embodiments, the city may be a D-rep in another D-Inf, such as a digital infrastructure of a geographical region including the city. Therefore, in the following description, a D-Inf can contain the digital representatives (D-Reps) of the real-world objects or entities associated with a given infrastructure, with related integration and application functions. The D-Inf can be referred to as an infrastructure, a system, an apparatus, or the like.

In the present disclosure, a method and system for digitally replicating a real-world infrastructure and providing services and modules for maintaining the digital replicate and associated digital representatives are described. The method and system are particularly adapted to provide a digital infrastructure (D-Inf) platform including functionalities for supporting data collection, exchange and analysis for the D-Inf. Therefore, in one embodiment, an improved wireless network platform, or structure, for maintaining a large-scale digital infrastructure is provided. The D-Inf described allows for controlling, managing, and maintaining digital representatives (D-Reps) of real-world entities included in a given infrastructure. For example, the D-Inf can contain the digital representatives of the real-world objects or entities associated with a physical or logical infrastructure and can further contain related integration and application functions. D-Inf sub-platforms, or specialized D-Infs, are also discussed.

In some embodiments, the D-Inf can be the sole provider of D-Reps, platform services, functionalities, and modules, and provides operational relationship between D-X boxes, which can refer to D-Inf instances or D-Reps, with the D-Inf services. The D-X boxes can be both the provider and consumer of these services. In alternative embodiments, the D-Inf can support third-party platforms. Therefore, the system and method provide scalable, low-latency and secure communication analysis and data management services to D-Reps and D-Inf sub-platform users, through the use of a D-Inf.

The method and system described herein advantageously allow for integrating D-Reps of a D-Inf within a wireless network, and for providing scalability while helping in reducing data exchange latency of using a distributed architecture. The method and system allow for simulating and performing scenarios, such as prediction scenarios, using the data from D-Rep(s) of real-life entities. A D-Inf can be implemented on elements of a wireless network such as base stations (BSs), core network elements, edge network elements, user equipment (UE), sensor networks, private factory networks, or a cloud of the network, for example. Through the implementation of the D-Inf, various services can be offered, such as Infrastructure Operation Optimization Service (OaaS), Infrastructure Asset Management Service (AMaaS), and Virtual Reality Services (VRaaS) can be provided by the D-Inf. The OaaS provides a solution for extensive optimization of infrastructure’s operation. As the infrastructure types can vary, the optimization methods optimization can also vary, based on the specific application. The D-Inf, through OaaS, can address these requirements as a global digitization platform. The AMaaS provides a solution for proactive lifecycle and maintenance management of assets, both physical and digital. D-Inf is unique in the sense that it is ubiquitous and that allows for fast, scalable and customizable deployment. The VRaaS enable extended, augmented and virtual reality services.

The method and system described herein also allow for extending capabilities of wireless networks by providing services implemented in the networks, and for optimizing network usage and D-Rep and D-Inf sub-platforms accuracy. Further the method and system allow for creating a highly connected environment that manages data and computing aspects efficiently.

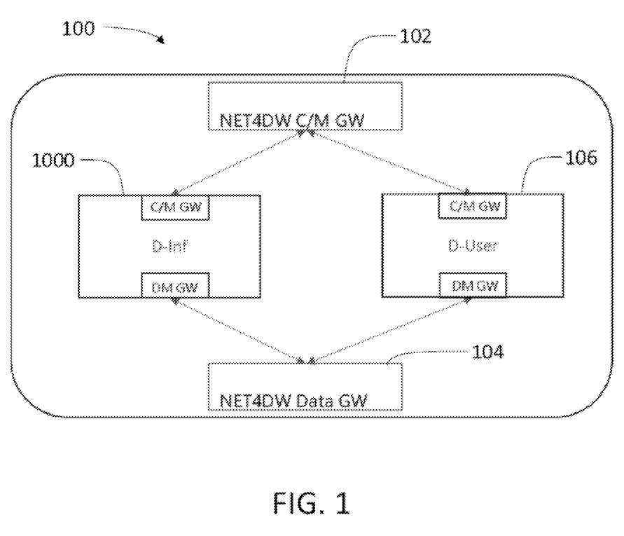

Referring to FIGS. 1 to 5, the system, apparatus or device, generally allows for replicating real-world environments using D-Reps and using the D-Reps to run simulations or algorithms adapted for accurately predicting and/or understanding the underlying real-world environments associated with the D-Reps. The system includes four main functions allowing the D-Inf to manage the D-Reps and to provide the simulations capabilities: a collection function, a connection function, a hosting function and an analysis function. Those functions can be provided by the D-Inf, depending on the application and ownership. In addition to these functionalities, the D-Inf can include sub-platforms further specialized for certain groups of applications. For example, operation optimization of networks is provided by a D-Net module/sub-platform.

Turning to the embodiment shown in FIG. 1, a D-Inf can be instantiated in an exemplary environment 100, such as a Digital World platform of wireless networks (NET4DW). The D-Inf 1000 can be accessed from the environment 100 through connecting an environment control and management gateway 102 with a control and management gateway of the D-Inf, and similarly through connecting an environment data gateway 104 with a data gateway of the D-Inf. Such connections enable interactions between the D-Inf 1000 and other entities of the environment 100, such as a digital user (D-User) 106. External entities, such as other service platforms including Artificial Intelligence platform for wireless networks (NET4AI) or Data management platform for wireless networks (NET4DATA), or third-party entities, can use the GWs to access NET4DW platform.

### Example Architecture of the System

The system, or D-Inf, provides a number of functions, or modules, together adapted to provide services for the digital representative of an infrastructure, or digital infrastructure (D-In). Those services can include data collection, management, storage, and exchange, for example. As D-Inf includes a number of D-Reps, the modules are adapted to provide functionalities to the D-Reps. For instance, a D-Inf of a smart city may include D-Reps of buildings and roads, wireless network elements, such as channel, BSs, relays, drones, satellites, NFs and servers, factories, production lines, and other types of robotic equipment, and intelligent transportation systems including city railways. Simulation and management services can be provided by implementing the D-Inf, so as to manage and control the D-Reps included in the D-Inf. By implementing the D-Inf, services such as AMaaS, which facilitates managing performance and condition/health of each individual object represented by a D-Rep and making longer-term planning for infrastructure, and VRaaS, which helps satisfying challenging requirements of virtual reality services, such as by reducing latency via accurate predictions, and pre-processing are provided.

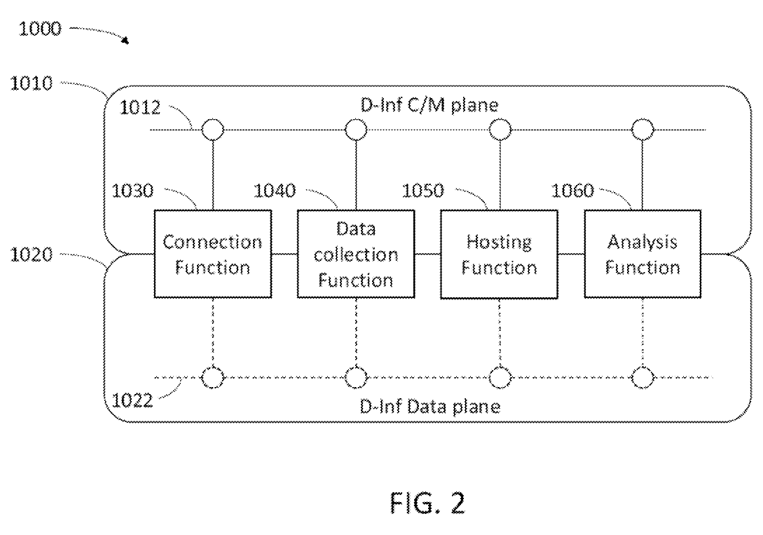

Turning to the embodiment shown in FIG. 2, a D-Inf, or system 1000, includes two communication planes, the control and management (C/M) plane 1010 and the data plane 1020, that provides a data exchange means, such as a data exchange protocol, between the D-inf and real-world infrastructures, for example. As will be described in more detail below, each plane allows for providing services for/to the D-Inf. For instance, the services are broadly separated into four groups: the Connection Function 1030, the Data Collection Function 1040, the Hosting Function 1050, and the Analysis Function 1060. Those functions, or modules, are accessed by the C/M plane 1010 via a C/M plane bus 1012, and by the Data plane 1020 via data plane bus 1022. In other embodiments, these functions can comprise sub-functions or function sections, where each sub-function is only accessible by one of the two planes 1010 and 1020.

For instance, the C/M plane 1010 is adapted to provide control and management services for the D-Inf, and the Data Plane 1020 provides data management, storage and analysis services to the D-Inf. In some embodiments, the services provided by the functions 1030-1060 are implemented by the D-Inf. In other embodiments, some services are obtained or accessed from other platforms and services, such as NET4AI or NET4Data. The functions 1030-1060 can be implemented separately as shown in FIG. 2, or they can be implemented as one C/M service accessible by the C/M plane and one data service accessible by the Data Plane. Other implementation options can be contemplated, such as implementing part of the functions in the cloud, and part of the functions at an edge node, included or excluded from the D-inf, or even within devices such as UEs. These implementations can be partitioned in various granularities, e.g., per plane, per function, or per sub-function, for instance. Furthermore, some of these functionalities can be provided by external D-Inf/D-Rep service providers. An external D-Inf is an additional D-Inf that may be in communication with the D-Inf described herein. Similarly, an external D-Rep is intended to refer to any D-Rep that is not contained by the D-Inf. For instance, an external D-Rep may be contained by the external D-Inf. For example, a D-Inf of a city may communicate with external D-Infs representing neighboring cities. The key point is that the D-Inf platform has the capability to provide fundamental functions to establish D-Reps and D-Inf sub-platforms, and to provide D-Inf services.

### Data Collection (DC) Function

The DC function, module, or service 1040 provides services for collecting data from D-Reps, real-world objects, or other D-Inf, for example. Still with reference to FIG. 2, the DC function 1040 provides separate interfaces for the C/M plane and the Data plane through which its different services are provided or accessed. Through the C/M plane, the DC function 1040 provides data-collection-related services. For example, the DC function 1040 is adapted to perform resource allocation for data collection services. The DC function 1040 can also prepare data collection mission tables and/or coordinate with a Mission Manager. In the present application, a data collection mission can refer to a set of sequential steps to be performed by one or more of the function 1030-1060 to collect data from one or more sources, connect to D-Reps, and perform data analysis, for instance.

The DC function 1040 is further responsible for performing network-wide configurations to facilitate performing data collection services. As will be detailed below, the DC function 1040 can be operatively connected and cooperating with the Connection Function 112 through the C/M plane, such as for configuration purposes. For instance, the DC function 1040 may prepare part of the configurations or requirements needed for data collection services and implement them via the Connection function 1030, or other connectivity-as-a-service providers, such as connectivity networks (CONET) or connection managers (CM). Performing the network-wide configurations can include, without being limited to, activating/deactivating pre-filtering, and configuring pre-filter parameters. Exemplary pre-filter parameters can include pre-filtering on/off periodicity, pre-filtering triggers, pre-filtering range to omit, and pre-filtering grids. A pre-filtering range to omit refers physical or logical range, such as a geographical distance range, within which data is to be omitted. For example, data associated with real-world objects located in a given range from a location are to be omitted, or not collected. For example, any data associated with real-world objects in a range of 5m, 10m, or 100m from a given real-world object are to be omitted. A pre-filtering grid can be used when a geographical region has grid-based approximations, as will be detailed below. In such cases, the grids can be used to filter out data in a more precise manner compared to range-based methods. Performing network-wide configurations can also include configuring and/or determining sensor battery level and expected life-based data collection configuration, e.g., frequency, buffering, number of hops, acceptable age, synchronization requirements. For example, the DC function 1040 can monitor battery life of sensors used to collect the real-world data from the real-world objects. In some embodiments, the DC function 1040 can further provide data discovery services for existing digital-world entities, allowing to obtain services from C/M planes of other entities or platforms on the network by connecting to other C/M plane gateways for instance. For example, connections with NET4DAM and NET4Data platforms can be established via their respective C/M plane gateways. The DC function 1040 can also monitor real-world objects, for instance via their respective sensors, to determine if new real-world data is available.

Through the Data plane 1020, the DC function 1040 provides data collection services including preparing tags, labels, location identification (ID) and other aspects of data to be retrieved, together with preventing data collection redundancies, if applicable, and applying pre-filtering to data collection.

As described above, data pre-filtering can be applied to data collection based on pre-filtering parameters. Considering the large amount of data that may be collected for/by D-Reps and D-Inf, it can become necessary or relevant to ensure that data collection is efficient, as to not overload the network or a node of the network. Some data may not be useful/viable due to low quality, duplicates from nearby real-world sensors and other purposes. Further, some data may be irrelevant or non-urgent. Similarly, some data may particularly relevant and urgent for a given application, such as for a given simulation to be performed by the D-Inf. In such cases, pre-filtering allows to classify the data before it uses bandwidth and processing resources of the network. Filtering the data can include one or more of merging similar or non-urgent (e.g. buffer-like) real-world data collected, cleaning or reducing the size of the real-world data collected, discarding defective real-world data collected, sampling redundant real-world data collected, labeling and/or tunneling urgent real-world data collected, and processing urgent real-world data collected by edge nodes of the platform.

In some embodiments, the DC function 1040 can, through the data plane 1020, obtain services from other services or platforms such as NET4DAM and NET4Data via Data Plane gateways.

### Connection Function

The Connection function, module, or service 1030 is responsible for providing connectivity between D-Reps of the D-Inf, and to D-Reps outside the D-Inf. The connectivity can be needed for a variety of purposes including data collection, network services, accessing to third-party services, and accessing to D-Reps within and outside of the D-Inf platform. In order to provide connectivity, the connection function 1030, through the C/M plane 1010, cooperates with other functions of the D-Inf, such as the DC function 1040. For instance, the connection function 1030 can provide Connectivity Manager (CM)-as-a-service, such as by obtaining services from a NET4Data platform. The connection function 1030 can also provide connection missions or mission maps in coordination with other functions. Connection missions can refer to a set of steps for connecting various elements of the D-Inf and/or external elements to the D-Inf. For instance, when there is a need for an analysis that cannot be performed with the current simulation environment through the analysis function 1060, described in more detail below, a service request is transmitted to connection function 112. The connection function 112 can produce the related mission map and communicate with other network service providers to execute the mission map.

The connection function 1030 further performs resource allocation for connectivity requirements of D-Reps, including D-Rep mobility management. D-Rep mobility management can be used when, for instance, a D-Rep being stored at an edge server connects with a main D-Rep in the cloud and may need to be migrated from one server to another to lower needed bandwidth, for instance. Migration may depend on the real-world device mobility, network congestion, server availability, location where most data is sensed for the D-Rep, that can differ from the location of the RW device, and delay/latency criteria, for example. In some cases, the Connectivity Manager of the networks can assist in D-Rep mobility management with regards to real-world device mobility management. The CM can trigger the D-Rep migration.

The connection function 1030 is further adapted to set up connectivity tunnels for external simulation environment, provide connectivity within the D-Inf platform if the platform is built in a multi-cloud way for instance, or includes edge components. The connection function 1030 also provides an authentication function that can be useful in a variety of scenarios and interfaces. For example, using a D-Rep-sensor connectivity, the connection function 1030 can perform authentication of the sensor and the data from the sensor. The connection function 1030 can also provide authentication functionalities with a D-Rep-Edge twin connectivity, to authenticate the edge twin and the cloud twins for data exchange. The authentication function may also be used with D-Rep-actuator connectivity, to authenticate the D-Rep before the actuator can perform the requested action. As another example, the authentication function can further be used for Crowd sensing user authentication, for data labelling.

Through the Data plane, the Connection function 1030 is responsible for Data plane aspects of connectivity, including managing the data plane gateway. The connection function 1030 also prepares/assists in-network data processing missions from the processing aspects of the mission. The connection function 1030 can also enable processing in-network data, including the distribution of processing algorithms.

### Hosting Module

Still referring to FIG. 1, the hosting function, module, or service 1050, through the C/M plane 1010, handles the C/M level aspects of hosting D-Reps, such as resource allocation for data storage, and provides security for D-Rep data storage. For instance, the hosting function 1050 is adapted to perform D-Rep lifecycle management in coordination with other functions and services, where lifecycle management can include request resource allocation and deallocation, and raising alarms, for example. Further, the hosting function 1050 provides asset management functionality, including maintaining, in real-time, multiple physical entities that are a part of a same D-Rep.

In some embodiments, the hosting function 1050 also provides D-Rep association management. For instance, a certain D-Rep can comprise other D-Reps instead of being associated with one or more real-world entities or objects. In this case, the one or more D-Reps can be associated to establish a “master D-Rep”. For example, an RIS may consist of tiles and controllers. The tile D-Reps may be associated with the controller D-Rep to represent the RIS D-Rep.

In preferred embodiments, the hosting function 1050 further provides D-Rep maintenance functionality. In collaboration with the analysis function 1060, the maintenance functionality allows the hosting function 1050 to verify the health of D-Reps. The health of a D-Rep may be defined in terms of accuracy, resource utilization efficiency, for example. D-Rep maintenance functionality also includes predicting the resource requirements for a given D-Rep and ensuring service continuity. The hosting function 1050 is also responsible for raising alarms if the D-Rep health deteriorates. D-Rep health and accuracy measurements can include fidelity, and the fidelity of the D-Rep can be optimized to minimize costs while maximizing benefits. Health checks are discussed more detailed later.

Through the Data plane, the hosting function 1050 provides data storage functions allowing to choose between types of storage, such as private storage or common storage options for certain data. If the data is to be stored privately, it may not be processed by the network and storage functions merely verify maintenance of the private storage. If the data is to be stored in common storage, the data storage functions arrange anonymization and labelling to prepare data for common storage. Once the data is ready, it is stored in a determined location. The storage location can depend on where the data is collected from, where the D-Reps that may need this data are located, which applications use this data, and sensitivity of data, such as low-latency or high priority, for instance. Multiple copies of the data can be generated by the data storage function, such as to be stored at an edge server, in different geographical regions, areas, networks, clouds, or data lakes, for example.

### Analysis Module

Still referring to FIG. 1, the analysis function, module, or service 1060 is adapted to provide C/M aspects of analysis tasks of D-Reps. The analysis function 1060 can collaborate with the connection function 1030 for internal and external connectivity requirements. For instance, the analysis function 1060 can determine the connectivity requirements for performing an analysis or simulation, and perform resource management for computation and storage requirements for performing the simulations or analyses. The analysis function 1060, through the C/M plane 1010, can also perform optimization for a simulation environment operation. Further, the analysis function 1060 provides simulation functionality by enabling simulation services, organizing access to the simulation library and helping to maintain simulation library.

The analysis function 1060 can also provide abstraction levels, allowing to define the amount of details, or granularity, to be used when simulating the real-world object. For instance, specialized D-Inf platforms, or sub-platforms, such as a D-NET sub-platform, can be implemented. A different application, or sub-platform, may need different D-Reps. For example, D-NET for optimization and D-NET for asset management may have different characteristics. Configuring the D-Inf can be performed by the analysis function 118 through the C/M plane function.

Through the data plane 1020, the analysis function 1060 provides an abstraction service. Based on the settings set by the analysis function 1060 through the C/M plane 1010, any abstraction-related data processing, classification, anonymization is carried out in the data plane function. The analysis function 1060 also provides validation and security services. The simulation/test library that can be used by the analysis function 1060 primarily contains simulators of well-known actors in the network, such as vendors and mobile network operators (MNOs). For example, the C/M plane 1010 of the D-Inf, using the analysis function 1060, is responsible for validation and security of the simulators and lesser-known actors may also be validated by more advanced security measures.

Further, the analysis function 1060 provides analysis services. Depending on the data, computation resources and the architecture of the D-Rep and D-Inf sub-platform, the simulations may run in the network, through the D-Inf C/M plane 1010 or by a third party such as by downloading a local copy/image of the simulator. Additionally, the analysis function 1060 provides a benchmark library. The simulation library serves to conveniently provide benchmark algorithms and methods for the MNO and/or the third party. These benchmark methods are used to test the performance/monitoring of D-Rep and D-Inf sub-platforms. The analysis function 1060 also provides a labelling function. Depending on applications, data labelling can be important, but also difficult and expensive. Wireless networks can make a difference if they are allowed to process the data in network and label it. Several methods of labelling can be used by the analysis function 1060, such as automated labelling with the help of classification algorithms, distributed learning, and crowd sourcing labelling, including communicating with wireless network users, application providers to label the data. The analysis function 1060, through the Data Plane 1020, provides the platform for crowd-sourcing-based labelling, such as by requesting the mission graph from the C/M plane 1010.

The analysis function 1060 can also provide an anonymization service, including anonymizing data for storage, in-network processing, and labelling, for instance. In some embodiments, the analysis function 1060 can also provide method optimization and algorithm selection services. For example, a sub-platform-1 can utilize method-1 for service-1, and sub-platform-2 can utilize method-2 for service-1. If method-1 provides better performance, such as in terms of accuracy, computational efficiency, or data efficiency, the analysis function 1060 can suggest method-1 to sub-platform-2. In order to provide this service, the analysis function 1060 requests the DC function 1040 to collect performance information of methods used for similar services.

### Example Interfaces

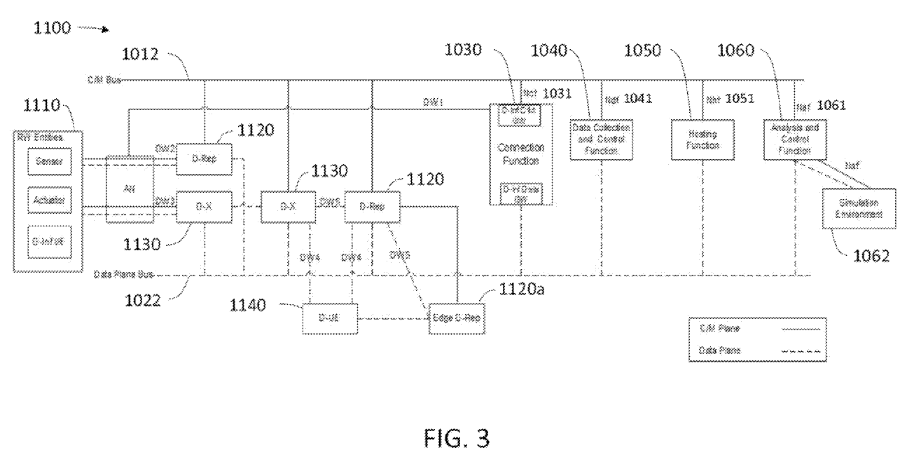

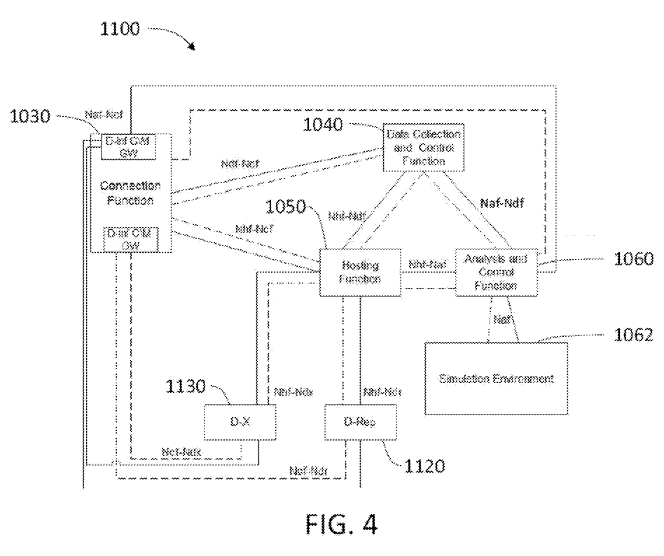

Referring now to the embodiment shown in FIG. 3, a D-Inf instance 1100 includes D-Reps, functions and interfaces. The D-Inf instance 1100 includes a plurality of interfaces that provide operative connections between the D-Reps 1120 of D-Inf and the functions 1030, 1040, 1050 and 1060 provided by the system 1000. Interfaces are also provided to operatively connect D-X boxes 1130, corresponding to other D-Reps or D-Inf sub-platform, with the functions 1030, 1040, 1050 and 1060. The interface definitions detailed below are exemplary and define functionality descriptions. In some embodiments, other function architectures can be used to implemented functions 1030-1060, resulting in different interfaces for operatively connecting the functions with other elements of the D-Inf. However, the interfaces define functionalities which remain valid across different architectures. In other words, a service that is defined for a specific interface can be implemented for another type of consumer via another interface. For instance, the Nhf-Ndf interface, described with reference to FIG. 4, is used to provide a data collection area setting service to the hosting function 1050. In some embodiments having an alternative partitioning scheme for instance, the DC function 1040 can provide the service of the Nhf-Ndf interface to a different function or consumer using a different interface. Therefore, it will be understood that while interface implementation may change, the services defined with regards with the exemplary embodiments of FIGS. 3 and 4, which use a 3^{rd} generation partnership project (3GPP) standard-like partitioning, are still provided. The interfaces shown in FIGS. 3 and 4 enable monitoring for fundamental digital world functions, which eventually facilitates co-existence of different types of service providers and granular service and performance management.

Ncf interface 1031 is the general interface for the connection function 1030. The interface operatively connects the connection function 1030 with other elements of the D-inf through the C/M plane 1010 and the data plane 1020. Ncf interface 1031 also connects with a NET4DW TW gateway allowing access to external elements. The Ncf interface 1031 can also provide communication means with other data-as-a-service providers, such as third-party providers, to facilitate data collection tasks. Ndf interface 1041 is the general interface of the DC function 1040.The interface operatively connects the DC function 1040 with other elements of the D-Inf through the C/M plane 1010 and the data plane 1020. Nhf Interface 1051 is the general interface of the hosting function 1050. The interface operatively connects the hosting function 1050 with other elements of the D-Inf through the C/M plane 1010 and the data plane 1020. The Nhf interface 1051 provides lifecycle management of D-Inf sub-platform entities and D-Reps. Naf interface 1061 is the general interface for the analysis function 1060. The interface operatively connects the analysis function 1060 with other elements of the D-Inf and is used to maintain the simulation environment, analysis libraries and data. For instance, Naf interface 1061 provides analytical information exchange through the data plane bus 1022, such as pre-filtering algorithms and data.

Turning to the embodiment shown in FIG. 4, internal interfaces of a D-Inf instance allow for interconnecting the elements of the D-Inf together. As the functions 1030, 1040, 1050 and 1060 interact with each other and with other elements of the D-Inf platform, specific services are provided through the interfaces of the functions, as described below.

### Example Connection Function Services

The Ncf interface 1031 connects with the other functions through their respective interfaces to provide a number of services to the D-Inf platform. Those services are carried through the interconnections of those interfaces. For instance, the interconnection interfaces for the connection function 1030 include an Naf-Ncf interface for connecting with the analysis function 1060, an Ndf-Ncf interface for connecting with the DC function 1050, and an Nhf-Ncf interface for connecting with the hosting function 1050.

The Naf-Ncf interface enables carrying analysis mission requests or mission information requests between the analysis function 1060 and connection function 1030. For instance, the services enabled by the Naf-Ncf interface can include a mission analysis service, where the connectivity requirements for a mission are derived. The services also include path and routing strategy analysis services, with which the connection function 1030 can request the analysis function 1060 to provide predictions over a path. Alternatively, the analysis function 1060 can utilize D-Reps and Nhf-Naf services for this purpose. The services provided by the Naf-Ncf interface can also include an external simulation environment tunnel establishment service by providing a tunnel specifically for external simulation environments.

The Nhf-Ncf interface enables exchanging connectivity requests, requirements, missions or mission requests from the hosting function 1050 to the connection function 1030, and acknowledgement and Internet Protocol (IP) addresses from the connection function 1030 to the hosting function 1050, for example. For instance, the services enabled by the Nhf-Ncf interface can include a secure end-to-end connectivity service between the D-Rep and its associated real-world entity, and secure connectivity service for re-using D-Reps. When a previously created D-Rep is no longer needed by the party that uses its services, it may be re-used for another party. That can save time and resources that are required to establish a new D-Rep, at the expense of certain anonymization and privacy protection measures. For example, before re-using a D-Rep, the identity and purposes of the previous owner/user of the D-Rep may be protected. The protection service is provided by the Nhf-Ncf interface. This service can be similar to formatting while preserving as much data/analysis as possible via permissions, negotiations and anonymizations. This method can also be used to enable a D-Rep to be used by multiple entities/customers/sub-platforms simultaneously. The secure connectivity service ensures that the traffic of each user is isolated. The services provided by the Nhf-Ncf interface also include a Quality-of-Service (QoS) setting service for connectivity, such as setting max delay and data rate, and a connectivity resource management and optimization service for D-X boxes and D-Reps.

The Ndf-Ncf interface is used to exchange messages regarding the connectivity requests, requirements, missions or mission requests for data collection. For instance, in response to a request sent from DC function 1040, the connection function 1030 can transmit, through the Ndf-Ncf interface, mission identification (ID), slice ID, device ID or IP addresses of the entities that will provide data. Further, authorization requests to access external databases can be exchanged between the DC function 1040 and connection function 1030 through the Ndf-Ncf interface. Other services provided by the Ndf-Ncf interface can include a data collection authorization service, in which the connection function 1030 provides authorization to the data sources as requested by the DC function 1040. The services also include a data collection anonymization service, allowing for the DC function 1040 to anonymize the data before it is distributed via the connection function 1030. The services further include an Age-of-information management service. As both connection properties and the data source can affect the age of data, these are controlled by the connection function 1030 and the DC function 1040, respectively.

The Ncf interface 1031 also enables the connection function 1030 to operatively connect with other elements of the D-Inf platform, such as D-Reps, and real-world entities. For instance, the Ncf-Ndx interface enables the connection function 1030 to connect with a D-X, while the Ncf-Ndr interface enables the connection function 1030 to connect with the D-Reps. Those interfaces also provide connectivity between the D-Reps and the real-world, such as the real-world objects associated with the D-Reps, D-X boxes and D-Reps and between D-Reps. In a preferred embodiment, the Ncf-Ndx and Ncf-Ndr interfaces are only instantiated when a new connection is requested, which prevents the need to instantiate a large number of interfaces when the number of D-Reps included in the D-Inf is large. In some embodiments, some services of the hosting function 1050 can be implemented within the D-Rep, as shown in FIG. 2. In those embodiments, the Ncf-Ndx and Ncf-Ndr interfaces can replace the Nhf-Ncf interface.

### Example Data Collection (DC) Function Services

The Ndf interface 1041 connects with the other functions through their respective interfaces to provide a number of services to the D-Inf platform. Those services are carried through the interconnections of those interfaces. For instance, the interconnection interfaces for the DC function 1040 are the Ndf-Ncf interface for connecting with the connection function 1030 as discussed above, the Nhf-Ndf interface for connecting with the hosting function 1050, and the Naf-Ndf interface for connecting with analysis function 1060.

The Nhf-Ndf interface enables exchanging data collection requests, requirements, missions, and mission requests for data collection of D-Reps and D-X boxes. Through the data plane, the Nhf-Ndf interface carries data traffic and also provides in-network data processing. For instance, the services enabled by the Nhf-Ndf interface can include a data collection area setting service. This service allows the hosting function 1050 to request data regarding a specific geographical region. The DC function 1040 is responsible for determining the data collection resources to accommodate. A data collection area only sets the area, but data to be collected can be provided as many different types of data. For example, it can be crowdsourced Quality-of-Experience (QoE) data collection in a region, or sensed channel quality data such as sensor data regarding water temperature for under-water sensors. The services enabled by the Nhf-Ndf interface can also include a data collection source setting service. This service allows the hosting function 1050 to prefer certain data sources over others. For example, the hosting function 1050 may prefer data to be collected only from certain type of sensor, such as pressure sensor or yield sensor, for a specific type of D-Rep. The services can also include a data collection frequency setting service, which allows for determining how frequently data to be requested, pulled, pushed, or transmitted. The services enabled by the Nhf-Ndf interface can also include a data source energy optimization service. This service allows for optimizing the energy spent to collect data of entities. For example, when drones are used as sensors, optimizing the energy expense of their trip can be one of the factors in determining how or when the data is collected, such that if the data is not urgent, data collection may wait for better weather conditions, for example. As another example, this service can be used in minimizing energy expenditure of a sensor network, especially multi-hop ad hoc sensor networks. The services can also include a data source lifetime optimization service, allowing for maximizing lifetime of the sensors or sensor networks or service duration of robot-sensors, such as drones. The services enabled by the Nhf-Ndf interface can also include a pre-filtering service, allowing to set or determine pre-filtering parameters. The hosting function 1050 can set many parameters for the pre-filtering, such as defining algorithms/methods to be used. In some embodiments, part or all of the settings presented herein can also be used as pre-filters. Pre-filters can be implemented in mid-network nodes, such as in routers, if in-network processing is implemented. The services can also include an age-of-information control service, allowing the hosting function 1050 to request the DC function 1040 to control the age-of-information of the data to be collected. This can include determining max AoI or average AoI.

The Ndf-Naf interface enables exchanging data collection requests, requirements, missions and mission requests to collect data for analysis. Some of the requests may trigger Ncf-Ndf messaging to ensure connectivity requirements are also met. In some embodiments, the analysis function 1060 may provide similar requests like the hosting function 1050 in using the Nhf-Ndf interface services. Some services enabled by the Ndf-Naf interface can include a model data collection service. For instance, the analysis function 1060 can request the DC function 1040 to collect, instead of raw data, models and/or features, such as in the case of transfer learning or federated learning. The analysis function 1060 may provide criteria to choose which models to collect, such as from a specific group of users or sensors, or from a specific. The services can also include an AI explanation data collection service. When other explainable AI methods are used, this service allows to collect their explanation, after acquiring permission, if necessary, to improve current AI methods. The services enabled by the Ndf-Naf interface can also include an AI algorithm performance data collection service, which allows for collecting the performance and characteristics information of other AI algorithms to improve method selection accuracy. For example, a sub-platform-1 may be using method-1 for service-1 while sub-platform-2 may be using method-2 for service-1. If method-1 provides better performance, in terms of accuracy, computational efficiency, or data efficiency for instance, this service can be used to suggest method-1 to sub-platform-2. In order to provide this service, the analysis function 1060 requests the DC function 1040 to collect performance information of methods used for similar services. Another service enabled by the Ndf-Naf interface includes a data labelling service, in which the analysis function 1060 provides the DC function 1040 with labels and classifications of the collected data.

### Example Hosting Function Services

The Nhf interface 1051 connects the hosting function 1050 with other functions through their respective interfaces to provide a number of services to the D-Inf platform. Those services are carried through the interconnections of those interfaces. As detailed above, the interconnecting interfaces of the hosting function 1050 include the Nhf-Ncf interface for connecting with the connection function 1030, the Nhf-Ndf interface for connecting with the DC function 1040. The Nhf-Naf interface enables connecting the hosting function 1050 with the analysis function 1060.

Further, the interconnection interfaces of the hosting function 1050 include an Nhf-Ndx interface for connecting with the D-X boxes of the D-Inf platform, and an Nhf-Ndr interface for connecting with the D-Reps of the D-Inf platform. The Nhf-Ndx interface enables exchanging hosting requirements with the D-X boxes, which can include D-Inf sub-platforms. The interface enables exchanging requests, requirements, missions and mission requests regarding D-Inf sub-platform entities, such as analysis requests, storage requests and service request, for instance. This interface can be further used to manage lifecycles of D-Inf sub-platform entities, which includes creating D-Reps, modifying D-Reps and terminating D-X boxes, for example.

The Nhf-Ndr interface enables exchanging hosting requirements between D-Reps of the D-Inf platform. For example, storage requirements, analysis requirements, and data collection requests can be exchanged between a D-Rep and the hosting function 1050 through the Nhf-Ndr interface. Furthermore, as the hosting function 1050 is responsible for lifecycle management of D-Reps as well as monitoring of their operation, the Nhf-Ndr interface enables exchanging health check messages and alarm messages between the hosting function 1050 and D-Reps, and exchanging messages for modifying, terminating or activating D-Reps.

The Nhf-Naf interface enables exchanging analysis requests, requirements, missions and mission requests for D-Reps and D-Inf sub-platforms. This interface is also used to obtain efficiency reports from the analysis function 1060 regarding the resource consumption of the D-Rep/D-X box in comparison to its accuracy and necessity to maintain service quality. Based on the report results, the hosting function 1050, through the Nhf interface 1051, can modify, deactivate, activate, and terminate D-Reps, D-X boxes and associated services. For instance, the Nhf-Naf interface enables services including an accuracy of D-Rep measurement service, a D-Rep quality measurement service, a D-X box quality measurement service, a fidelity level optimization for D-Rep service, a fidelity level optimization for sub-platform service, and an Interpreting or explaining service for specific standards. For instance, the hosting function 1050 can request, through the Nhf-Naf interface, the analysis function 1060 to explain the AI algorithm to comply with standardization, such as an ISO standard, or to improve or fine tune algorithms.

### Example Analysis Function Services

The Naf interface 1061 connects the analysis function 1060 with the other functions through their respective interfaces to provide a number of services to the D-Inf platform. As detailed above, the Naf-Ncf interface enables connecting the analysis function 1060 with the connection function 1030, the Naf-Ndf interface enables connecting the analysis function 1060 with the DC function 1040, and the Nhf-Naf interface enables connecting the analysis function 1060 with the hosting function 1050. The Naf interface 1061 also enables maintaining the simulation environment 1062, analysis libraries and data. Through the data plane, the Naf interface 1061 enables data analytical information to be exchanged with the simulation environment, such as pre-filtering algorithms and data. Further, the Naf interface 1061 enables controlling the simulation environment in both C/M and Data Plane. Resource allocation, resource efficiency and other control is done by exchanging messages with both internal and external simulation environments. In some embodiments, for the external environments, the Naf interface 1061 may be supported by connection function 1030.

Referring back to FIG. 3, additional interfaces are provided, enabling the D-Inf to interface with external elements, such as other D-Reps, real-world objects, edge D-Reps, which are D-Reps located outside the D-Inf, and user equipment, for example. The additional interfaces include DW1, DW2, DW3, DW4 and DW5 interfaces. The DW1 interface connects the connection function 1030 with the AN, and enables connecting with the C/M gateway of the D-Inf through the C/M plane, and with the data plane gateway of the D-Inf through the data plane. The gateways allow external access to and from the D-Inf platform, such as for accessing third-party resources. The DW2 interface enables connecting a D-Rep with its associated real-world entity. For example, the DW2 interfaces enables connecting a D-Rep with one or more sensors associated with its real-world entity or object 1110, for collecting data from the one or more sensors. The DW2 interface can support different types and formats of data requirements depending on the type of sensors, for instance. This interface can be adapted through the connection function 1030.

The DW3 interface, similarly, connects the D-Rep with its associated real-world object or entity 1110, and more particularly with one or more actuators associated with the real-world entity. The interface is used to control the one or more actuators, and therefore the real-world entity, in response to a simulation, a prediction, or a generated alarm, for instance. In some embodiments, the DW3 interface facilitates low-latency and secure communications between the digital world and the real world, as latency requirements can be critical in sing real-world objects depending on a generated alarm, for instance. The DW3 interface can also enable security and authentication communication between a D-Rep and its associated real-world object to validate that control of the one or more actuators is allowed. The DW4 interface enables connecting a D-Rep of a D-Inf platform or sub-platform to another D-Inf sub-platform. Further, the DW4 interface connects a D-Rep to digital user equipment (D-UE) 1140, corresponding to a digital representation of a user equipment, allowing to communicate with the D-UE 1140 for analysis, data collection, and alarm propagation, for instance. The interface facilitates requests and missions to be exchanged through the C/M plane and the Data Plane between D-Inf and D-UE entities. The DW5 interface connects a D-Rep with an external D-Rep, or edge D-Rep 1120a, for analysis and data collection, for example. For instance, a D-Inf sub-platform may utilize external D-Reps, such as when a D-City sub-platform requests data from the D-Rep of a construction site or electric distribution facility. The DW5 allows for connecting to the D-Rep of the construction site which is external to the D-Inf sub-platform.

It will be understood that the DW1, DW2, DW3, DW4 and DW5 interfaces described above generally allow connecting the D-Reps and/or D-X boxes of a D-Inf platform to external or edge entities. The number of interfaces instantiated depends on specific applications.

### Example D-Inf Sub-Platforms

As mentioned above, specialized versions of the D-Inf platform, i.e., D-Inf sub-platforms, include specific functionalities adapted for specific applications of the D-Inf platform. These sub-platforms can use the services provided by the D-Inf platform and detailed above, such as AMaaS, OaaS or VRaaS, for example. These services may be combination for certain applications, services or requests. For example, a D-Net sub-platform, discussed below, can provide a combination of OaaS, where the network is optimized, and AaaS, where the network is maintained. These services can have unique functions/functionalities for a given sub-platform, or may use the common functions of D-Inf platform for their purposes.

In some embodiments, part of the services are fundamentally provided by the network while some other services can be provided by a third parties and supported by the network in which the D-Inf is implemented. In some embodiments, the D-Inf only supports the third-party digital world applications. When the services are provided by the D-Inf, the network maintains the D-Reps, performs simulations and analysis, collects data and so on. When the D-Inf supports third-party applications, the network may be responsible only for data collection, or even act as a pipeline between the data source and a digital-world application provider.

The sub-platforms can also provide additional specialized services. Non-limiting examples of sub-platforms are detailed below.

### D-Net

A first sub-platform is a digital network (D-Net) platform. D-Net sub-platform can be used by a mobile network operator (MNO) to optimize a mobile network. The MNO needs data collection, storage and processing services for network devices and other network entities, such as communication channels. By instantiating a D-Net, the sub-platform collects sensing and monitoring data and keeps D-Reps updated and utilizes actuators in the real world, using the data plane 1020. The sub-platform further allocates resources for efficient data collection and processing, such as on the simulation environment, and manages the simulation library through the C/M plane 1010.

The D-Net sub-platform can use AMaaS and OaaS at the same time. AMaaS allows the D-Net sub-platform to maintain infrastructure and schedule maintenance for various network elements from BS antenna repairs to sensor battery replacements. OaaS allows the D-Net platform to optimize network operation, such as to improve communication reliability or reduce energy expenses, for instance. The predictions provided by D-Net are the key enabler to obtain such benefits.

D-Net is the platform for the D-Rep of networks, where the specific functionalities include unification of network and sensing data by multiple tenants or operators, for instance. D-Net services provide the D-Reps of network elements, including one or more of base stations, SAGIN elements, radio channels, routers, switches, servers and the transport network. D-Net services create a virtual version of the real network and the scale of the D-Net can be adjusted from one element to a global network, depending on the purposes or customer requests, for instance.

The D-Net can create D-Reps at varying fidelity levels and accuracy levels compared to their associated real-world elements. The D-Net sub-platform can have an overall accuracy level, or each element can have its accuracy or fidelity level reported individually. The overall accuracy or fidelity level can be varying with time, region, mission, purpose, and application, for instance, and calculated in several ways, including an average of fidelity level of each element, an average of fidelity level of the most prominent elements for the purposes of the service, mission, or application using weighted average with binary weights, a weighted average of the fidelity levels of each element, where more important elements are represented with higher weights, or based on the element(s) with minimum or maximum fidelity level, for example.

### D-City

Another exemplary sub-platform is a digital city (D-City) sub-platform. The D-City is the platform for smart city applications. Similar to D-Net, the D-City platform can also use both AMaaS and OaaS services. AMaaS for D-City allows the user to precisely schedule maintenance for elements such as aging buildings, roads and bridges. OaaS allows D-City to optimize the operation of the infrastructure, e.g., adjust thermostats, lighting, traffic lights, grid power and so on. Specific functionalities include smart grid D-Rep management, building D-Reps, construction site and connectivity between various D-Reps for city-wide applications. A specialized version of the AMaaS is the main service provided by the D-City module.

For instance, a municipality may need to assess hurricane risks of the city, which is helped by using a D-City sub-platform digitally representing the municipality. Further, a construction site, associated or not to the municipality, can have a D-Rep of the site to optimize the construction process. The D-Rep can include point clouds of the elements in the site, for tracking beams or debris, for instance. In order for the municipality to assess the hurricane risks, the D-City sub-platform needs the debris information of the construction site. The D-Inf, through the D-City instance, provides the connectivity and data unification services between the D-City and the construction site D-Rep.

### D-Factory

In another example, a sub-platform is provided for a factory (D-Factory). The sub-platform provides asset management services and operation optimization services for the factory. For instance, D-Inf C/M ensures the synchronization requirements satisfaction for machine type communications is ensured through the C/M plane of the D-Factory, and timely responses can be generated for faulty situations. Further, the analysis function of the sub-platform can perform predictions regarding lifecycles of assets, and the predictions can be broadcasted to associated entities.

### D-Robo

Another specialized D-Inf sub-platform, the D-Robo, is provided for robotics applications. The D-Robo can be implemented to control and manage a fleet of robots, such as robots used for elderly care services using service robots. D-Reps of the service robots are used to optimize their services and minimize latency on making decisions. The D-Robo platform provides asset management, analysis, data management and connectivity to the fleet owner. Further, Data pre-filtering, cleaning, anonymization and labelling performed by the D-Robo sub-platform through the D-Inf Data Plane 1020. In some embodiment, the D-Robo sub-platform can provide asset management, analysis and hosting services for the D-Reps of the service robots.

The D-Robo sub-platform can include sensing aspects for locating the robots. Further, D-Robo includes specific functionalities for D-Reps and D-Inf sub-platforms of robotic elements, such as factories, elderly assistance robots and other applications with robotic elements. The D-Robo sub-platform also provides specialized AMaaS and OaaS services for such elements, such as robot IDs, detailed task IDs, management and mapping of these tasks and capabilities between various Robots from various manufacturers. In some embodiments, this is a dynamic process that is based on learning the Robot behavior and task nature/features. D-Robo box uses environmental sensing and awareness as well as obtaining feedback from robot users, such as elderly people or other human supervisors, or feedback from drivers and other sensing devices, that are collected.

The exemplary sub-platforms described above can also connect with each other using one or more interfaces also described above. For example, the D-Robo sub-platform can connect with the D-City sub-platform to collect city-related information for managing robots used in the city. The D-Inf platform therefore enables collaboration between the sub-platform, enabling scaling the use of D-Reps. In some embodiments, this kind of collaboration can be one of the enablers or AI native networks.

### Example D-Inf Instance

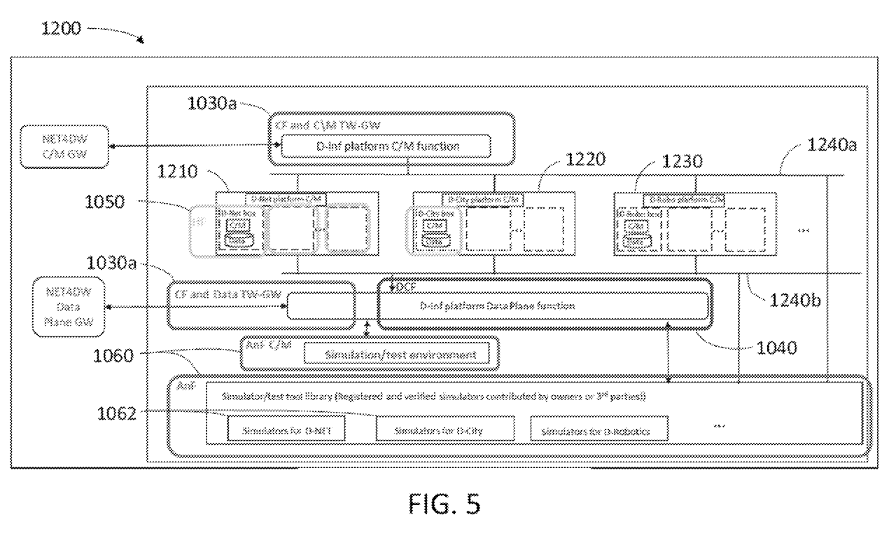

Turning to the embodiment shown in FIG. 5, an environment 1200 includes a plurality of D-Inf sub-platforms: a Digital Network (D-Net) sub-platform 1210, a Digital City (D-City) sub-platform 1220, and a Digital Robot (D-Robo) sub-platform 1230. The sub-platforms 1210, 1220 and 1230 are all specialized instantiations of D-Inf with some specialized functions implemented for each sub-platform, as described above. The sub-platforms are connected to the DC function 1040, the connection function 1030a, 1030b, the hosting function 1050, and the analysis function 1060 detailed above using common busses 1240a and 1240b. For instance, the sub-platforms 1210, 1220 and 1230 can be connected through the C/M plane of the D-Inf via the common bus 208a while the sub-platforms can be connected through the data plane of the D-Inf via the common bus 208b.

As these sub-platforms of D-Inf are connected to C/M and Data Plane via a common bus, the sub-platforms can also be connected to each other. For instance, D-Net platform may utilize data and analysis form D-City platform. Further, all sub-platforms access to the Simulation and test environment by the D-Inf Data Plane function. D-Inf C/M and Data Plane TW GW service can be provided by the connection function 1030a, 1030b. Part or all of the services for the sub-platforms 1210, 1220 and 1230 may be implemented in the sub-platforms directly, or, regardless of how specific they are, as C/M and Data Plane functions and services common to all the D-Inf sub-platforms. The latter implementation can allow multiple D-X boxes, such as D-Inf sub-platforms or modules, to access similar functionalities easily and can help reduce duplication. In some embodiments, for example, the TW-GW functionality can be implemented as a common C/M and Data Plane function for all sub-platforms, the DC function may be used to allow data exchange between sub-platforms, the hosting function may be used to maintain D-Reps in a D-X box, and the analysis function may maintain the simulation environment resources in the C/M plane and manage the contents of the library in the Data plane.

### Example NET4DW Service Module

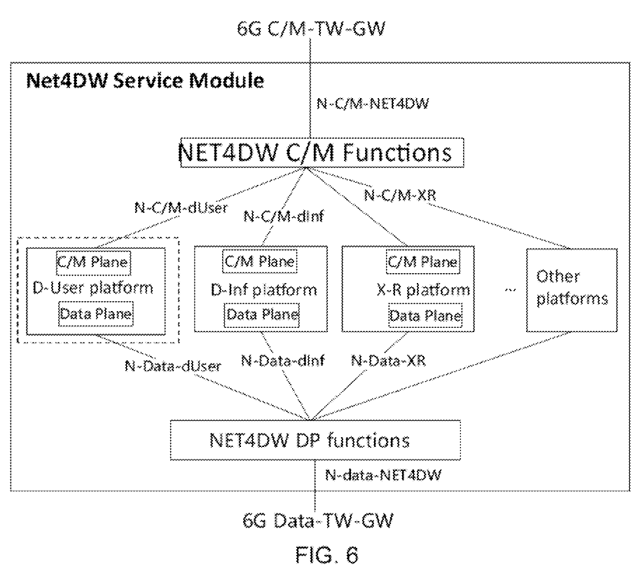

Referring now to the embodiment of FIG. 6, in possible embodiments, a digital world network service module is schematically illustrated, which can provide Digital World (DW) services and which may include a capability to construct, control and manage objects and entities in a digital or virtual world. The digital world network service module may also be referred to herein as a “NET4DW” service module. A digital world can be defined as a digital realization or implementation of a physical world, including for example people, animals, objects, such as robots, cars, lights, and infrastructures, such as roads, organizations, buildings and factories. For the purposes of this disclosure, the terms digital entities, DE, D-XX, DE module or D-XX module may be used to represent any of above items. The NET4DW service module provides different services to allow applications to run or be executed in the DW. In particular, the NET4DW service module may include D-Users, which correspond to digital representations of physical users (P-Users). Currently, some form of digital representation of a user is available in certain metaverses or servers such as Facebook^{TM}, Amazon^{TM}, Google^{TM}, etc. The required representation can vary from application to application and can vary from from using user data to controlling personal items and actions on behalf of the user. A D-User can comprise a set of parameters and data corresponding to characteristics of a real, physical person or animal, including not only nominative data, such as a name, age, address, but also other characteristics, such as real-time location, heartbeat, medical conditions, preferences, physiological data, the user context, environmental context, mobility, past activities which can be gathered from sensors or not. A D-User may also comprise one or more software applications or modules that can simulate, predict or replicate the behavior or condition of the real, physical person associated with the D-User. Operational data defines operations performed by functions of the one or more D-Reps or D-Users. Operational data may comprises one or more of: processing of input data, modifying input data, forwarding input data or processed data to a specified destination, deleting input data, creation of other functions and life cycle management of other functions, resource assignment for other functions, modifying other functions.

FIG. 6 provides an exemplary high-level architecture of an NET4DW service module.

As shown in FIG. 6, NET4DW may include D-User platforms, D-Inf platforms and any other DW platforms such as X-R platforms. These digital entities are commonly termed D-XX modules in this document. D-Inf platform may contain digital representatives (D-Reps or D-Rep modules) of different physical objects, such a buildings, roads or lights, and D-Inf can replicate an infrastructure such as a city, as an example only.

In the diagram C/M refers to control and management plane and DP refers to data plane. Net4DW C/M functions are the control and management functions of the NET4DW to manage and coordinate the platform interactions required for different DW applications. It may also include the C/M G/W function though which the NET4DW C/M functions interact with the external C/M functions. Similarly, DP functions are the data plane functions such as routing and data processing functions. Each platform has its own C/M and DP functions and they may connect to Net4DW functions through G/W functions. A D-User platform can comprise a single user platform (for example, an induvial) or multiple users in the same user platform (for example, a group of friends or a family).

Details of NET4DW functions, which may need to be instantiated when the NET4DW platform is created, are needed for its proper creation and operation.

In addition, the digital entities (DE or D-XX) used in the NET4DW and the NET4DW operations may require privacy preservation. In particular, the DW operations need to be isolated from the hosting networks. Therefore, the hosting platforms discussed in this application can be used for providing in-network DWs as well.

One technical problem that is addressed in this application is creating a proper isolated hosting platform (HOP) for digital entities (DE), including for example D-Users, inside the hosting network which can instantiate the entities when needed. The functions needed in the hosting network to create the hosting platform and the functions inside the hosting platform which can enable it to create digital entities, including D-Users, are also included.

This application also provides different options the network operator could have to create the platform. Platform can be, for example, a single entity platform, such as a D-User platform, or a multiple entity platform, such as a multi-D-User platform, a NET4DW platform or isolated function module inside the hosting network. The creation procedures are described separately for each case. The functional architecture of the platform with main functions and interfaces are also described.

The hosting network can be a trusted network for a user or an untrusted network. In the untrusted case, this application further provides methods to avoid the hosting network from accessing the entity data when a user wants to process data inside the network or when a user shares data with 3^{rd} parties.

In addition, in the untrusted case, this application provides methods to create the hosting platform to avoid the hosting network getting information about the external servers the digital entities (such as D-User) access.

In addition, in the untrusted case, this application describes how the HOP can be created to anonymously access the 3^{rd} party servers and also avoid the hosting network to get that information.

### Example Operating Environment

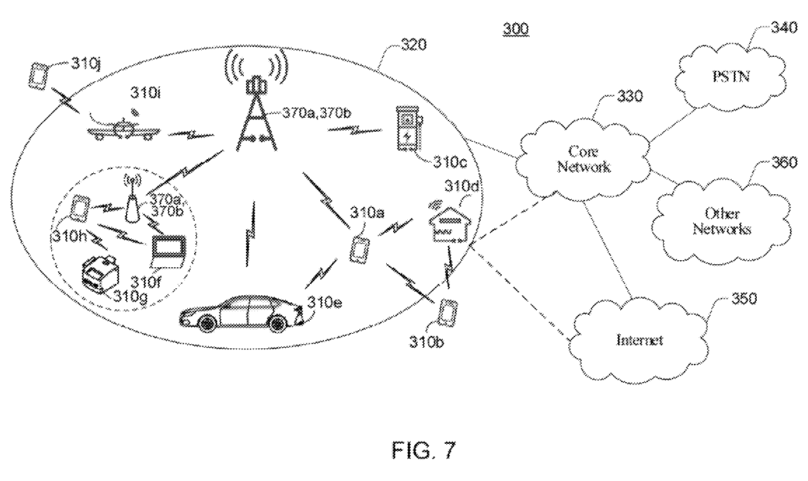

Referring now to the embodiment of FIG. 7, as an illustrative example without limitation, a simplified schematic illustration of a communication network system is provided. The radio access network (RAN) 320 may be a next generation (e.g. 6th generation (6G) or later) radio access network, or a legacy (e.g. 5th generation (5G), 4th generation (4G), 3th generation (3G) or 2nd generation (2G)) radio access network. In some implementations, 6G radio access refers to the next generation air interface of standards which may comprise both terrestrial networks (TNs) and non-terrestrial networks (NTNs). One or more communication electronic devices (ED), including for example User Equipment (UE), 310a, 310b, 310c, 310d, 310e, 310f, 310g, 310h, 310i, 310j (generically referred to as 310) may be interconnected to one another or connected to one or more network nodes (370a, 370b, generically referred to as 370) in the radio access network 320. A core network 330 may be a part of the communication system and may be dependent or independent of the radio access technology used in the communication system 300. Also, the communication system 300 comprises a public switched telephone network (PSTN) 340, the internet 350, and other networks 360.

In general, the communication system 300 enables multiple wireless or wired elements to communicate data and other content. The communication system 100 may provide content, such as voice, data, video, and/or text, via broadcast, multicast, groupcast, unicast, etc. The communication system 300 may provide a wide range of communication services and applications including enhanced Mobile Broadband (eMBB) services, ultra-reliable low-latency communication (URLLC) services, massive machine type communication (mMTC) services, integrated sensing and communication (ISAC), immersive communication, massive communication, Hyper reliable and low-latency communication, ubiquitous connectivity, integrated AI and communication and other services that can be provide by the future generation communication system. The communication system 100 may provide other services/applications such as earth monitoring, remote sensing, passive sensing and positioning, navigation and tracking, autonomous delivery and mobility, etc.

The communication system 300 may operate by sharing resources, such as carrier spectrum bandwidth, among its constituent elements.

The communication system 300 may include a terrestrial communication system and/or a non-terrestrial communication system. The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. The heterogeneous network may achieve better overall performance through efficient multi-link joint operation, more flexible functionality sharing, and faster physical layer link switching between terrestrial networks and non- terrestrial networks.

The terrestrial communication system and the non-terrestrial communication system could be considered sub-systems of the communication system.

The electronic device 310 is used to connect persons, objects, machines, etc. The electronic device 310 may be widely used in various scenarios including, for example, cellular communications, device-to-device (D2D), vehicle to everything (V2X), peer-to-peer (P2P), machine-to-machine (M2M), MTC, internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each electronic device 310 represents any suitable end user device for wireless operation and may include such devices (or may be referred to but not limited to) as a user equipment (UE) or a user device or a terminal, a wireless transmit/receive unit (WTRU), a mobile station, a fixed or mobile subscriber unit, a cellular telephone, a station (STA), a MTC device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the forgoing devices, among other possibilities. Future generation electronic devices 110 may be referred to using other terms.

Network node 370 may be a base station. A base station is a network element in radio access network responsible for radio transmission and reception in one or more cells to or from the user equipment. The base stations170a-170b may be known by other names in some implementations, such as a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a positioning node, among other possibilities. The base stations 370a-370b may be a macro base station (BS), a pico BS, a relay node, a donor node, or the like, or combinations thereof.

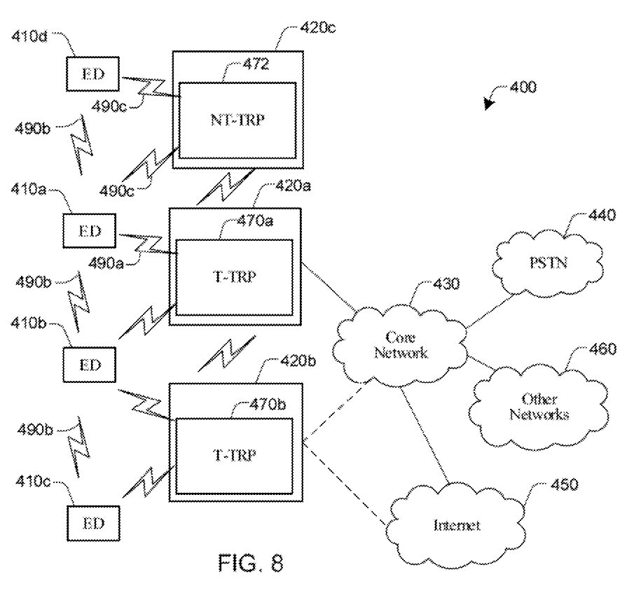

With reference to FIG. 8, the communication system 400 (e.g. communication system 300) enables multiple wireless or wired elements to communicate data and other content. The purpose of the communication system 400 may be to provide content, such as voice, data, video, and/or text, via broadcast, multicast, groupcast, unicast, etc. The communication system 400 may operate by sharing resources, such as carrier spectrum bandwidth, between its constituent elements. The communication system 400 may include a terrestrial communication system and/or a non-terrestrial communication system. The communication system 400 may provide a wide range of communication services and applications (such as earth monitoring, remote sensing, passive sensing and positioning, navigation and tracking, autonomous delivery and mobility, etc.). The communication system 400 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non- terrestrial networks.

The terrestrial communication system and the non-terrestrial communication system could be considered sub-systems of the communication system. In the example shown in FIG. 8, the communication system 400 includes electronic devices (ED) 410a, 410b, 410c, 410d (generically referred to as ED 410, which may include User Equipment (UE)), radio access networks (RANs) 420a, 420b, a non-terrestrial communication network 420c, a core network 430, a public switched telephone network (PSTN) 440, the Internet 450, and other networks 460. The RANs 420a, 420b include respective base stations (BSs) 470a, 470b, which may be generically referred to as terrestrial transmit and receive points (T-TRPs) 470a, 470b. The non-terrestrial communication network 420c includes an access node 472, which may be generically referred to as a non-terrestrial transmit and receive point (NT-TRP) 472.

Any ED 410 (e.g. ED 310) may be alternatively or additionally configured to interface, access, or communicate with any T-TRP 470a,470b and NT-TRP 472, the Internet 450, the core network 430, the PSTN 440, the other networks 460, or any combination of the preceding. In some examples, ED 410a may communicate an uplink and/or downlink transmission over a terrestrial air interface 490a with T-TRP 470a. In some examples, the EDs 410a, 410b, 410c, and 410d may also communicate directly with one another via one or more sidelink air interfaces 190b. In some examples, ED 410d may communicate an uplink and/or downlink transmission over a non-terrestrial air interface 190c with NT-TRP 472.

The air interfaces 490a and 490b may use similar communication technology, such as any suitable radio access technology. For example, the communication system 400 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 490a and 490b. The air interfaces 490a and 490b may utilize other higher dimension signal spaces, which may involve a combination of orthogonal and/or non-orthogonal dimensions.

The non-terrestrial air interface 490c can enable communication between the ED 410d and one or multiple NT-TRPs 472 via a wireless link or simply a link. For some examples, the link is a dedicated connection for unicast transmission, a connection for broadcast transmission, or a connection between a group of EDs 410 and one or multiple NT-TRPs 472 for multicast transmission.

The RANs 420a and 420b are in communication with the core network 430 to provide the EDs 410a, 410b, and 410c with various services such as voice, data, and other services. The RANs 420a and 420b and/or the core network 430 may be in direct or indirect communication with one or more other RANs (not shown), which may or may not be directly served by core network 430, and may or may not employ the same radio access technology as RAN 120a, RAN 420b or both. The core network 430 may also serve as a gateway access between (i) the RANs 420a and 420b or EDs 410a110b, and 410c or both, and (ii) other networks (such as the PSTN 440, the Internet 450, and the other networks 460). In addition, some or all of the EDs 410a, 410b, and 410c may include functionality for communicating with different wireless networks over different wireless links using different wireless technologies and/or protocols. Instead of wireless communication (or in addition thereto), the EDs 410

0a, 410b, and 410c may communicate via wired communication channels to a service provider or switch (not shown), and to the Internet 450. PSTN 440 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 410a , 410b, and 410c may be multimode devices capable of operation according to multiple radio access technologies, and incorporate multiple transceivers necessary to support such.

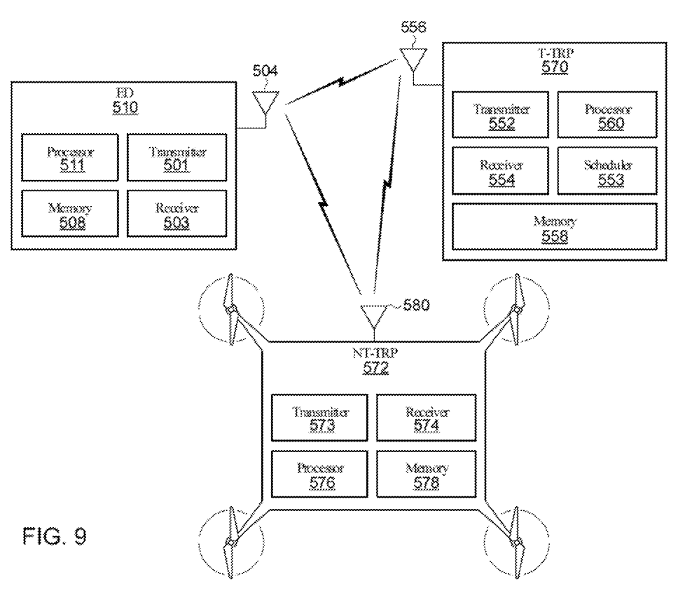

With reference to the embodiment shown in FIG. 9, another example of an ED 510 and a base station 570a, 570b 5and/or 570c are shown. The ED 510 is used to connect persons, objects, machines, etc. The ED 510 may be widely used in various scenarios including, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 510 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the forgoing devices, among other possibilities. Future generation EDs 510 may be referred to using other terms. The base station 570a and 570b is a T-TRP and will hereafter be referred to as T-TRP 570. Also shown FIG. 9, a NT-TRP will hereafter be referred to as NT-TRP 572. Each ED 510 connected to T-TRP 570 and/or NT-TRP 572 can be dynamically or semi-statically turned-on (i.e., established, activated, or enabled), turned-off (i.e., released, deactivated, or disabled) and/or configured in response to one of more of: connection availability and connection necessity.

The ED 510 includes a transmitter 501 and a receiver 503 coupled to one or more antennas 504. Only one antenna 504 is illustrated to avoid congestion in the drawing. One, some, or all of the antennas 504 may alternatively be panels. The transmitter 501 and the receiver 503 may be integrated, e.g. as a transceiver. The transceiver is configured to modulate data or other content for transmission by at least one antenna 504 or network interface controller (NIC). The transceiver is also configured to demodulate data or other content received by the at least one antenna 504. Each transceiver includes any suitable structure for generating signals for wireless or wired transmission and/or processing signals received wirelessly or by wire. Each antenna 504 includes any suitable structure for transmitting and/or receiving wireless or wired signals.

The ED 510 includes at least one memory 508. The memory 508 stores instructions and data used, generated, or collected by the ED 110. For example, the memory 508 could store software instructions or modules configured to implement some or all of the functionality and/or embodiments described herein and that are executed by one or more processing unit(s) (e.g., a processor 510). Each memory 508 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 510 may further include one or more input/output devices (not shown) or interfaces (such as a wired interface to the Internet 350 in FIG. 7). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The ED 510 includes the processor 511 for performing operations including those operations related to preparing a transmission for uplink transmission to the NT-TRP 572 and/or the T-TRP 570; those operations related to processing downlink transmissions received from the NT-TRP 572 and/or the T-TRP 570; and those operations related to processing sidelink transmission to and from another ED 510. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 503, possibly using receive beamforming, and the processor 511 may extract signaling from the downlink transmission (e.g. by detecting and/or decoding the signaling). An example of signaling may be a reference signal transmitted by the NT-TRP 572 and/or by the T-TRP 570. In some embodiments, the processor 511 implements the transmit beamforming and/or the receive beamforming based on the indication of beam direction, e.g. beam angle information (BAI), received from the T-TRP 570. In some embodiments, the processor 511 may perform operations relating to network access (e.g. initial access) and/or downlink synchronization, such as operations relating to detecting a synchronization sequence, decoding and obtaining the system information, etc. In some embodiments, the processor 511 may perform channel estimation, e.g. using a reference signal received from the NT-TRP 570 and/or from the T-TRP 570.

Although not illustrated, the processor 511 may form part of the transmitter 501 and/or part of the receiver 503. Although not illustrated, the memory 508 may form part of the processor 511.

The processor 511, the processing components of the transmitter 501, and the processing components of the receiver 503 may each be implemented by the same or different one or more processors that are configured to execute instructions stored in a memory (e.g. in the memory 508). Alternatively, some or all of the processor 511, the processing components of the transmitter 501, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

The T-TRP 570 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 570 may refer to the forgoing devices or refer to apparatus (e.g. a communication module, a modem, or a chip) in the forgoing devices.

In some embodiments, the parts of the T-TRP 570 may be distributed. For example, some of the modules of the T-TRP 570 may be located remote from the equipment that houses the antennas 256 for the T-TRP 570, and may be coupled to the equipment that houses the antennas 556 over a communication link (not shown) sometimes known as front haul, such as common public radio interface (CPRI). Therefore, in some embodiments, the term T-TRP 570 may also refer to modules on the network side that perform processing operations, such as determining the location of the ED 510, resource allocation (scheduling), message generation, and encoding/decoding, and that are not necessarily part of the equipment that houses the antennas 556 of the T-TRP 570. The modules may also be coupled to other T-TRPs. In some embodiments, the T-TRP 570 may actually be a plurality of T-TRPs that are operating together to serve the ED 510, e.g. through the use of coordinated multipoint transmissions.

The T-TRP 570 includes at least one transmitter 552 and at least one receiver 554 coupled to one or more antennas 556. Only one antenna 556 is illustrated to avoid congestion in the drawing. One, some, or all of the antennas 556 may alternatively be panels. The transmitter 552 and the receiver 554 may be integrated as a transceiver. The T-TRP 570 further includes a processor 560 for performing operations including those related to: preparing a transmission for downlink transmission to the ED 510, processing an uplink transmission received from the ED 510, preparing a transmission for backhaul transmission to the NT-TRP 572, and processing a transmission received over backhaul from the NT-TRP 572. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 511 may also perform operations relating to network access (e.g. initial access) and/or downlink synchronization, such as generating the content of synchronization signal blocks (SSBs), generating the system information, etc. In some embodiments, the processor 560 also generates an indication of beam direction, e.g. BAI, which may be scheduled for transmission by a scheduler 553. The processor 260 performs other network-side processing operations described herein, such as determining the location of the ED 510, determining where to deploy the NT-TRP 572, etc. In some embodiments, the processor 560 may generate signaling, e.g. to configure one or more parameters of the ED 510 and/or one or more parameters of the NT-TRP 572. Any signaling generated by the processor 560 is sent by the transmitter 552. Note that “signaling”, as used herein, may alternatively be called control signaling. Signaling may be transmitted in a physical layer control channel, e.g. a physical downlink control channel (PDCCH), in which case the signaling may be known as dynamic signaling. Signaling transmitted in a downlink physical layer control channel may be known as Downlink Control Information (DCI). Signaling transmitted in an uplink physical layer control channel may be known as Uplink Control Information (UCI). Signaling transmitted in a sidelink physical layer control channel may be known as Sidelink Control Information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to Radio Resource Control (RRC) protocol signaling or Media Access Control – Control Element (MAC-CE) signaling.

The scheduler 553 may be coupled to the processor 560. The scheduler 553 may be included within or operated separately from the T-TRP 170. The scheduler 553 may schedule uplink, downlink, sidelink, and/or backhaul transmissions, including issuing scheduling grants and/or configuring scheduling-free (e.g., “configured grant”) resources. The T-TRP 170 further includes a memory 558 for storing information and data. The memory 258 stores instructions and data used, generated, or collected by the T-TRP 170. For example, the memory 558 could store software instructions or modules configured to implement some or all of the functionality and/or embodiments described herein and that are executed by the processor 560.

Although not illustrated, the processor 560 may form part of the transmitter 552 and/or part of the receiver 554. Also, although not illustrated, the processor 560 may implement the scheduler 553. Although not illustrated, the memory 558 may form part of the processor 560.

The processor 560, the scheduler 553, the processing components of the transmitter 252, and the processing components of the receiver 554 may each be implemented by the same or different one or more processors that are configured to execute instructions stored in a memory, e.g. in the memory 558. Alternatively, some or all of the processor 560, the scheduler 553, the processing components of the transmitter 552, and the processing components of the receiver 554 may be implemented using dedicated circuitry, such as a programmed FPGA, a hardware accelerator (e.g., a GPU or AI accelerator), or an ASIC.

Although the NT-TRP 572 is illustrated as a drone only as an example, the NT-TRP 572 may be implemented in any suitable non-terrestrial form, such as satellites and high altitude platforms, including international mobile telecommunication base stations and unmanned aerial vehicles, for example. Also, the NT-TRP 572 may be known by other names in some implementations, such as a non-terrestrial node, a non-terrestrial network device, or a non-terrestrial base station. The NT-TRP 572 includes a transmitter 572 and a receiver 574 coupled to one or more antennas 580. Only one antenna 580 is illustrated to avoid congestion in the drawing. One, some, or all of the antennas may alternatively be panels. The transmitter 572 and the receiver 574 may be integrated as a transceiver. The NT-TRP 572 further includes a processor 576 for performing operations including those related to: preparing a transmission for downlink transmission to the ED 510, processing an uplink transmission received from the ED 510, preparing a transmission for backhaul transmission to T-TRP 570, and processing a transmission received over backhaul from the T-TRP 570. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 576 implements the transmit beamforming and/or receive beamforming based on beam direction information (e.g. BAI) received from the T-TRP 570. In some embodiments, the processor 576 may generate signaling, e.g. to configure one or more parameters of the ED 510. In some embodiments, the NT-TRP 572 implements physical layer processing, but does not implement higher layer functions such as functions at the medium access control (MAC) or radio link control (RLC) layer. As this is only an example, more generally, the NT-TRP 572 may implement higher layer functions in addition to physical layer processing.

The NT-TRP 572 further includes a memory 578 for storing information and data. Although not illustrated, the processor 576 may form part of the transmitter 572 and/or part of the receiver 574. Although not illustrated, the memory 578 may form part of the processor 576.

The processor 576, the processing components of the transmitter 572, and the processing components of the receiver 574 may each be implemented by the same or different one or more processors that are configured to execute instructions stored in a memory, e.g. in the memory 578. Alternatively, some or all of the processor 576, the processing components of the transmitter 572, and the processing components of the receiver 574 may be implemented using dedicated circuitry, such as a programmed FPGA, a hardware accelerator (e.g., a GPU or AI accelerator), or an ASIC. In some embodiments, the NT-TRP 572 may actually be a plurality of NT-TRPs that are operating together to serve the ED 510, e.g. through coordinated multipoint transmissions.

The T-TRP 570, the NT-TRP 572, and/or the ED 510 may include other components, but these have been omitted for the sake of clarity.

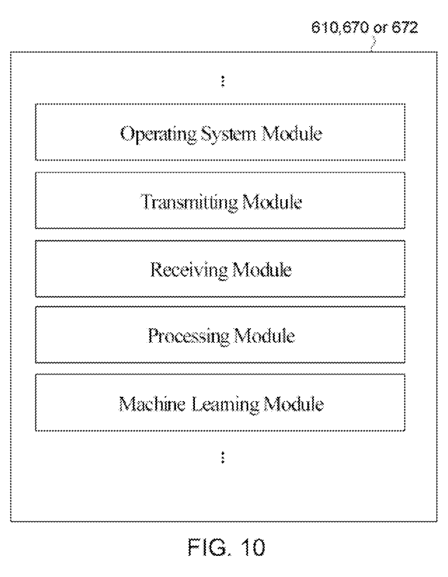

One or more steps of the embodiment methods provided herein may be performed by corresponding units or modules, according to the embodiment shown in FIG. 10. FIG. 10 illustrates units or modules in an exemplary device, such as in the ED 610, in the T-TRP 670, or in the NT-TRP 672. For example, a signal may be transmitted by a transmitter, a transmitting unit, or by a transmitting module. A signal may be received by a receiver, a receiving unit, or by a receiving module. A signal may be processed by a processor, a processing unit, or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It may be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the EDs 610, the T-TRP 670, and the NT-TRP 672 are known to those of skill in the art. As such, these details are omitted here.

The solution described in the application is applicable to a next generation (e.g. sixth generation (6G) or later) network, or a legacy (e.g. 5G, 4G, 3G or 2G) network.

In possible embodiments, the proposed 6G System architecture is defined to support 6G XaaS services by using techniques such as Network Function Virtualization and Network Slicing. The 6G System architecture utilizes service-based interactions between 6G services.

### Example Service-Based Architecture

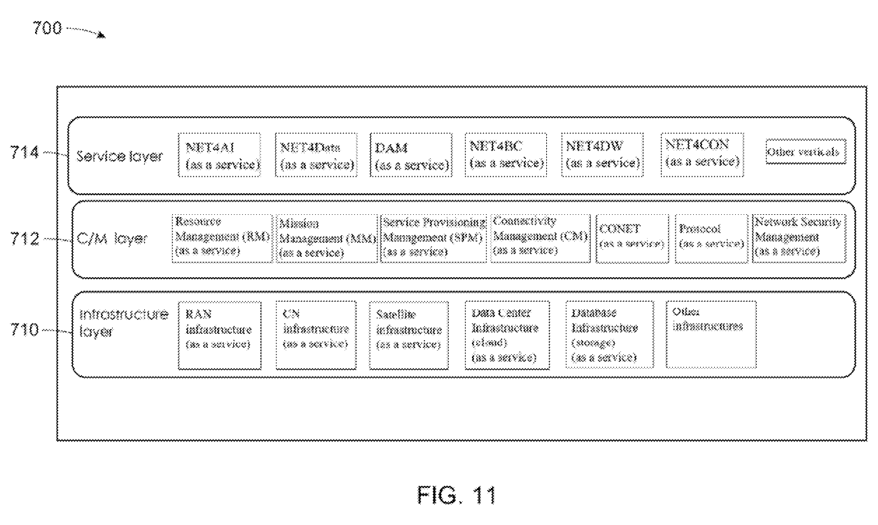

In possible embodiments, the network system 700, which can be a 6G network system, leverages service-based architecture and XaaS concept. XaaS services in the 6G System are categorized into three layers 710, 712, 714. A possible embodiment of a 6G System conceptual structure is shown in the embodiment shown in FIG. 11.

In possible embodiments, Infrastructure Layer 710 includes infrastructures supporting 6G services. Among them are wireless networks (RAN, CN) infrastructures, Cloud/data center infrastructures, satellite networks, storage/database infrastructures, and sensing networks, and etc. These infrastructures can be provided by a single provider or by multiple providers.

Each of the infrastructures can have its control and management functions, denoted as C/M functions, for infrastructure management. Each of these infrastructures can be one type of Infrastructure as a Service.

In possible embodiments, Control and Management (C/M) layer 712 includes control and management services of the 6G System. They are developed and deployed by using slicing techniques and utilizing resource provided by infrastructure layer. 6G services in Control and Management (C/M) layer 712 may include:

A Resource Management module comprising Resource Management (RM) as a Service functions, which can provide a capability of life-cycle management of a variety of slices and over-the-air resource assignment to wireless devices;

A 6G mission module defined as a service provided to customers by the 6G System. A mission can be a set of services which is provided by a single 6G XaaS service or a type of services that needs contributions from multiple XaaS services;

A Mission Management module comprising Mission Management (MM) as a Service functions, which may provide a capability to program provisioning of XaaS services at Service Layer to provide mission services;

A CONET module comprising Confederation Network (CONET) as a Service functions, which may provide a capability to enable multiple partners to jointly provide 6G services. This capability is provided by confederation formation, mutual authentication, mutual authorization among partners and negotiation of agreement on recording and retracing of selected actions performed by partners, in order to assure a trustworthy environment of 6G System operations

A Service Provisioning Management module functions, which comprises Service Provisioning Management (SPM) as a Service, to provide a capability of control and management of 6G service access by customers and provisioning of requested services. The capability is provided by unified mutual authentication, authorization and policy, key management, QoS assurance and charging between any pair of XaaS service provider and customer. The customers include end-customers not only in physical world, but also digital representatives in digital world;

A Connectivity Management module , which comprises Connectivity Management (CM) as a Service functions, to leverage 5G connectivity management functions, but with extension to include digital world;

A Protocol as a Service module, which comprises Protocol as a Service functions to provide a capability to design service customized protocol stacks for identified interfaces. The protocol stacks can be pre-defined for on-demand selection, or can be on-demand designed;

A Network Security as a Service module, which comprises Network Security as a Service functions to provide a capability for owners of infrastructures to detect potential security risks of their infrastructures;

A XaaS module, comprising XaaS services in the C/M Layer support control and management 712 of the 6G System itself and also provide support to verticals if requested. One example is that RM service can serve RAN for over-the-air resource management and can also provide service to a vertical for the vertical’s over-the-air resource allocation to its end-customers. The XaaS in C/M layer can be deployed by using slicing technique.

Service Layer 714 may include 6G services which provide services to customers. In the 6G System structure 700, the following modules may be included:

An AI service module, denoted as NET4AI as a Service. Artificial Intelligence service functions provide AI capability to support a variety of AI applications;

A DAM module comprising Service of data collection, data sanitization, data analysis and data delivery functions, denoted as DAM as a Service, this service provides a capability of lifecycle management of statistic data, including acquisition, de-privatization, analysis and delivery of data which are information statistic data from any types of sensors, devices, network functions etc.;

A NET4Data module, comprising Service of storage and sharing of data, denoted as NET4Data as a Service. This service module provides a capability to trustworthily storage and share data under the control of owners of data and following recognized authorities’ regulations on control of identified data;

A NET4DW module, comprising Service to provide digital world, denoted as NET4DW as a Service. The Digital World module (or system) provide a capability to construct, control and manage digital world. Digital world is defined as digital realization of physical world;

A block chain module, comprising 6G block chain service is denoted as NET4BC as a Service. 6G connectivity service is denoted as NET4Con as a Service. This service provides a capability to support 6G block chain services;

A NET4CON module, comprising Enhanced connectivity service, e.g., network for connectivity (NET4CON) as a service. This service provides a capability to support exchange of messages and data among new 6G services.

All XaaS services at this Layer may developed and deployed by using resources provided in the infrastructure and utilizing Network Function Virtualization and Slicing techniques. The capability of each of the 6G services is provided by its control and management (C/M) functions and service specific data process functions.

In addition to support 6G XaaS services at Service Layer 714, the 6G System 700 leverages 5G System for provisioning of vertical services. The difference between 6G XaaS services and other verticals are that a vertical is a pure customer which needs other XaaS services to enable its operation, while each of XaaS services provide their capabilities to 6G customers.

Any pair of XaaS services of the 6G System may also be mutual customer and provider of each other. Some examples are that an infrastructure owner providing its resource to XaaS services in the Service Layer 714 and C/M Layer 712; RM services may need the capabilities provided by NET4AI, DAM and NET4DW for its resource management for vertical slicing; CONET service and NET4Data service may need the capability provided by NET4BC for their operation.

The structure and associated modules/platform of the proposed 6G System may provide the following functionalities and advantages:

Define Basic XaaS Services by decoupling comprehensive types of services into basic XaaS services. A basic XaaS service provides unique capability to enable a specific type of service, such as NET4AI service, NET4DW service, DAM service, NET4Data service, Block chain service, mission management service, etc.

Allow joint operation of the 6G System by multiple partners;

Define Data Plane of the 6G System which includes processing functions of data plane of XaaS services. Programing the interconnection of these functions, by mission management service, enables to support a variety of customized customer services;

Simplify 6G System architecture by categorizing basic control services and management services and combining them as basic XaaS services in Control and Management (C/M) Layer;

Define C/M Plane of the 6G System which includes C/M functions in XaaS services and may include 5G CP (e.g., AMF) depending on implementation options;

Define Basic Architecture Structure (BAS) which is a unified basic structure with minimized number of interfaces and is independent of types of infrastructures.

Simplify standardization, development and deployment of the 6G System using the BAS concept, while supporting a variety of infrastructure deployment scenarios;

Adapt to a variety of deployment scenarios by applying the BAS or a subset of it to infrastructures based on capability, capacity and requirement of the infrastructure networks;

Leverage SBI interface concept and apply SBI interaction in both 6G C/M plane and 6G data plane;

Simplify SBI interfaces by introducing trustworthy GWs in Data Plane and C/M Plane of the 6G System;

Improve trustworthiness from perspectives of operation of the 6G System by introducing CONET capability, NET4BC capability and anonymous service provisioning provided by the trustworthy GWs in the C/M plane and data plane of the 6G System;

Improve trustworthiness from perspective of end customer privacy protection by unified mutual authentication, IDM, data sanitization and etc. provided by SPM service, DAM service and 6G Block Chain service;

Simplify roaming management of wireless devices, in physical world and digital world, by unified authentication including all participated partners and customers.

Support multiple development paths from 5G System to 6G System by defining multiple architecture options without incurring much efforts due to the introduction of the BAS concept;

Support backward compatibility by utilizing benefits of SBA and its add-on feature. 5G users can use the 6G System to access 5G services;

Support future extension by adding new XaaS services with minimized impact on standardization and deployment, due to the introduced anonymous service provisioning concept implemented in trustworthy GWs in 6G C/M plane and in 6G data plane.

### NET4CON Service Framework

The NET4CON service of the Service layer 714 provides a plurality of functionalities that can be provided by an owners of infrastructures, such as a RAN provider or a CN provider, for instance. The NET4CON service is the owner of one or more gateways used to communicate with other services or elements in the network. For instance, the network can be defined and accessed through two communication planes, the control and management (C/M) plane and the data plane. Therefore, in an embodiment, a gateway, referred to as C/M-TW-GW, is provided for accessing the C/M plane, and another gateway, referred to as Data-TW-GW, is provided for accessing the data plane. The NET4CON service is the owner of the C/M-TW-GW and the Data-TW-GW. Through the ownership of the C/M-TW-GW and the Data-TW-GW, the NET4CON service provides a capability of anonymous interactions between XaaS services. The NET4CON service is further adapted to control and manage a BAS domain, infrastructure domain, or administration domain, and to enable 1) interactions between 6G XaaS services provided by same or different partners and 2) interactions between 6G XaaS services and verticals and XaaS services deployed in 3rd party infrastructures/clouds.

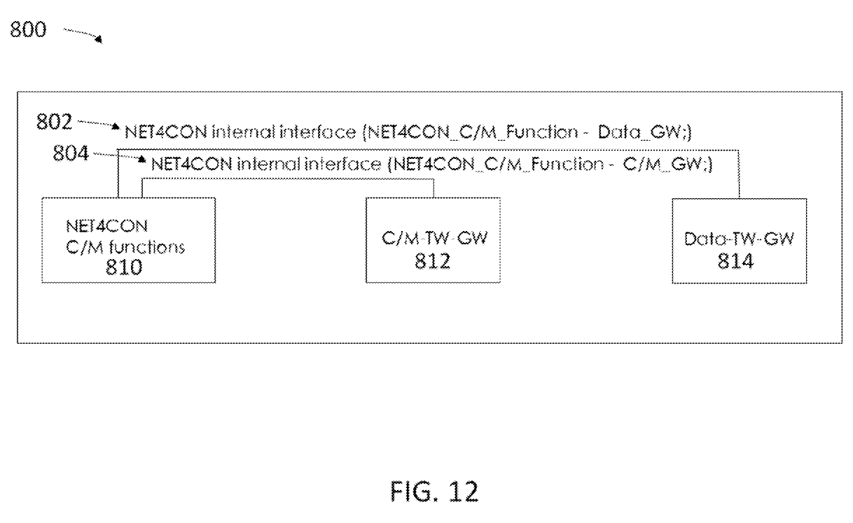

Turning to the embodiment shown in FIGS. 12-14, the NET4COM architecture 800, in one Basic Architecture Structure (BAS) domain or one administration domain, generally includes Logical Elements, internal interfaces, and external interfaces. The Logical Elements include NET4CON C/M functions 810, the C/M-TW-GW 812 and Data-TW-GW 814. The internal interfaces include a NET4CON_C/M_function – C/M-TW-GW 804, operatively connecting the NET4CON C/M functions with the C/M-TW-GW, and a NET4CON_C/M_Function – Data-TW-GW 802, operatively connection the NET4CON C/M functions with the Data-TW-GW.

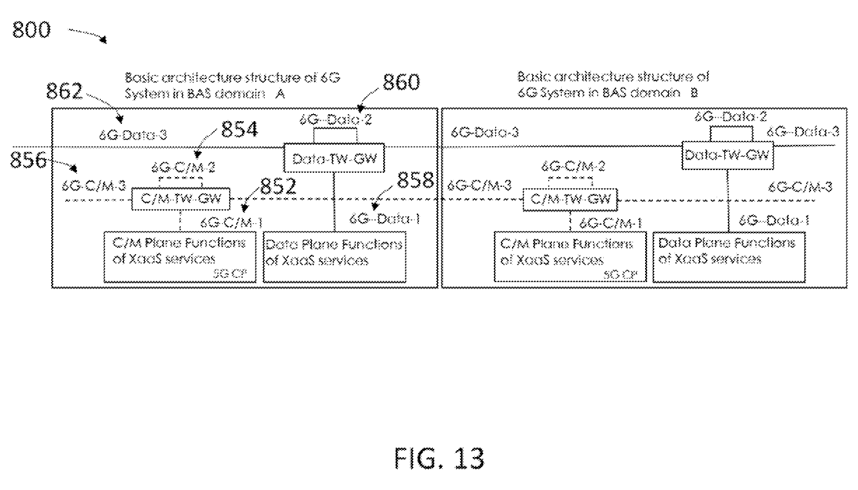

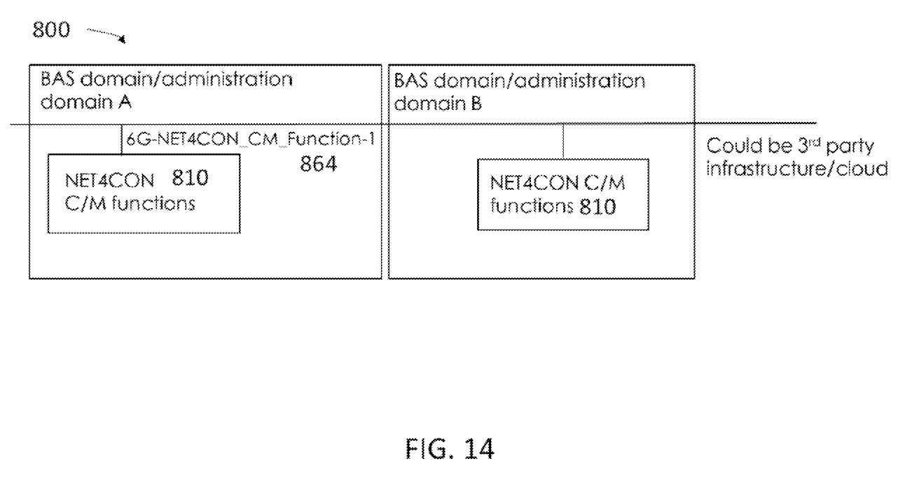

The External interfaces of the NET4CON architecture 800, better seen in FIGS. 13 and 14, generally enable exchanging data between the NET4CON and external elements. The External interfaces include 6G-C/M-1 852, 6G-C/M-2 854 and 6G-C/M-3 856 interfaces connecting with the C/M-TW-GW. The External interfaces further include 6G-Data-1 858, 6G-Data-2 860 and 6G-Data-3 862 interfaces connecting with the Data-TW-GW. The External interfaces also include NET4CON-NET4CON and External-NET4CON interfaces, for connecting with the NTE4CON C/M functions, and serving C/M-TW-GW and Data-TW-GW interfaces.

### NET4CON C/M Function

The NET4CON C/M function controls and manages the topology of Basic Architecture Structure (BAS) domain or infrastructure domain, including the logical connections between XaaS services and GWs deployed in the domain, and controls access of 6G devices, D-Users, or any type of customers, to the 6G system, or network, by managing the C/M session and the data session.

The NET4CON C/M function is further responsible for Information acquisition, which can include obtaining XaaS service deployment profile from external services, such as CONET and XaaS services, and obtaining XaaS service authorization profile. The NET4CON C/M function is further adapted to manage the BAS or administration domain logical topology, which includes, without being limited to:

Configuring GWs for setting up secured connections among these GWs, including 3rd parties’ GWs,

Configuring C/M-TW-GWs and C/M plane functions of XaaS services in a BAS domain for setting up secured connections,

Configuring C/M-TW-GWs on service authorization of XaaS services and deployment of XaaS services,

Configuring C/M-TW-GWs and Verticals for setting up secured connection between the C/M-TW- GWs and verticals when needed,

Configuring Data-TW-GWs and data plane functions of XaaS services in a BAS domain for setting up secured connections, and

Configuring Data-TW-GWs and verticals for setting up secured connections between the Data-TW-GWs and verticals when needed.

The NET4CON C/M function also manages device C/M session and Data session for mobile devices and D-User (anchor) in the NET4DW. This includes controlling the establishment of device data session, which is the logical connection between a device and its serving Data-TW-GW. This also includes maintaining information for devices on their serving C/M session and Data session and mapping between RBs and sessions.

The NET4CON C/M is further adapted to manage log and load of the GWs. In one embodiment, the NET4CON C/M configures the C/M-TW-GWs and Data-TW-GWs on log of interactions of XaaS services on C/M plane and data plane. The NET4CON C/M also tracks load status of C/M-TW-GWs and Data-TW-GWs, and manages load balance of GWs by tearing down current secured connections of XaaS service functions from some of GWs and re-establish secured connections with other GWs.

### C/M-TW-GW

A C/M-TW-GW is adapted to provide capabilities to connect C/M plane functions of XaaS services and verticals in a Basic Architecture Structure domain (BAS) or infrastructure domain, in order to enable anonymous and secured C/M plane interaction among XaaS services, following authorization profiles of XaaS services. In an embodiment, the C/M-TW-GW function receives configuration from NET4CON C/M functions or other entities and maintains authorization profiles of XaaS services and manages local Active authorization table to control authorization for XaaS service consumers and providers. The C/M-TW-GW further receives configuration from NET4CON C/M functions or other entities and maintains deployment profiles of XaaS services, and also establishes and maintains one secured tunnel with each of XaaS services and verticals in a BAS or infrastructure domain. Other C/M-TW-GW functions include performing security tunnel related operations, performing Lawful C/M plane message inspection and message log, recording load of each of such tunnels to enable load management, and conducting multiple operation modes in procedures of C/M plane messages exchanges among XaaS services.

### Data-TW-GW

A Data-TW-GW provides capabilities to connect data plane functions of XaaS services and verticals in a Basic Architecture Structure domain (BAS) or infrastructure domain, to enable anonymous and secured data plane interaction among XaaS services and to manage assured service performance. The Data-TW-GW is adapted to perform a plurality of functionalities that can include:

Establishing and maintaining one secured tunnel with data plane function(s) of each of XaaS services and verticals in a BAS domain/infrastructure domain,

Receiving configuration for data packets exchange among XaaS services,

Recording load of each of such tunnels and updated to NET4CON C/M function to enable load management,

Performing decryption and encryption operation when transferring data packets in case needed,

Translating Data formats to enable XaaS service data plane function understand the format of data received,

Processing protocols for QoS and routing based on configuration by mission management or be carried in protocol stacks - the Data-TW-GW can process the protocol headers and performs corresponding QoS handling and routing operation,

Logging traffic, based on configuration, to support network operation optimization, service performance assurance and charging, and

Performing lawful inspection, under configuration.

### Internal Interfaces of NET4CON Service

As mentioned above, the NET4CON service includes NET4CON_C/M_Function – C/M_GW and NET4CON_C/M_Function – Data_GW interfaces. The NET4CON_C/M_Function – C/M_GW interface allows for the NET4CON C/M function to configure C/M-TW-GWs, including XaaS service deployment profiles and XaaS service authorization profiles, for instance. The interface also allows for the NET4CON C/M function to configure a C/M-TW-GW as a serving C/M-TW-GW of one device/D-user. The NET4CON_C/M_Function – C/M_GW interface further allows for the C/M-TW-GW to forward some C/M messages to NET4CON C/M function for decision making, such as serving C/M-TW-GW selection for a device. The interface also allows for the NET4CON C/M function to send its decision types of messages to C/M-TW-GW, and for the C/M-TW-GW to report its logged load information for load management by NET4CON C/M function.

The NET4CON_C/M_Function – Data_GW interface allows for the NET4CON C/M function to configure Data-TW-GWs, including XaaS service deployment profiles and XaaS service authorization profiles, for instance. The interface also allows for the NET4CON C/M function to configure a Data-TW-GW as a serving Data-TW-GW of one device/D-user. The interface further allows for the Data-TW-GW to report its logged load information for load management by NET4CON C/M function.

### External Interfaces of NET4CON Service

The external interfaces of NET4CON service, shown in FIG. 13, are interfaces between the NET4CON service and other XaaS services and functions implemented in 3rd party infrastructures.

The interface 6G-C/M-1 852 is used for receiving and sending C/M plane messages between a C/M-TW-GW and a C/M function of a XaaS service. The interface 852 further enables interactions between C/M functions of different XaaS services. The interface 6G-C/M-2 854 is used for interactions between C/M-TW-GWs within a BAS/infrastructure domain. The interface 6G-C/M-3 856 is used for interactions between C/M-TW-GWs belonging to different BAS or infrastructure domains. The interface 856 is further used for connecting the C/M-TW-GW with 3rd parties, the interface being used for interactions with the 3rd party’s control and management functions, such as for information exposure.

### External Interfaces of Data-TW-GW

The interface 6G-Data-1 858 is used for receiving and sending data plane packets between a Data-TW-GW and a Data process function of a XaaS service. The interface 858 also enables data packet exchange between data process functions of different XaaS services. The interface 6G-Data-2 860 is used for interactions between Data-TW-GWs within a BAS or an infrastructure domain. The interface 6G-Data-3 862 is used for interactions between Data-TW-GWs belonging to different BAS or infrastructure domains. The interface 862 is further used for connecting with 3rd party networks or infrastructures, such as to provide interactions with 3rd party’s data plane functions. For instance, the interface 862 can be used for sending data packets to 3rd parties’ infrastructure or receiving data plane packets from 3rd parties’ infrastructure.

### External Interfaces of NET4CON C/M Function

Turning to FIG. 14, a BAS or administration domain A can be connected with another BAS or administration domain B using interface 6G-NET4CON_C/M_Function-1 864. For instance, the interface 864 enables direct communication between NET4CON C/M functions between domains A and B. The interface 864 also enables direct communication between a BAS domain which has connection with 3rd parties’ infrastructure and the control/management function of the 3rd parties. The interface 864 can be used for coordinating data plane processes and data packets exchange.

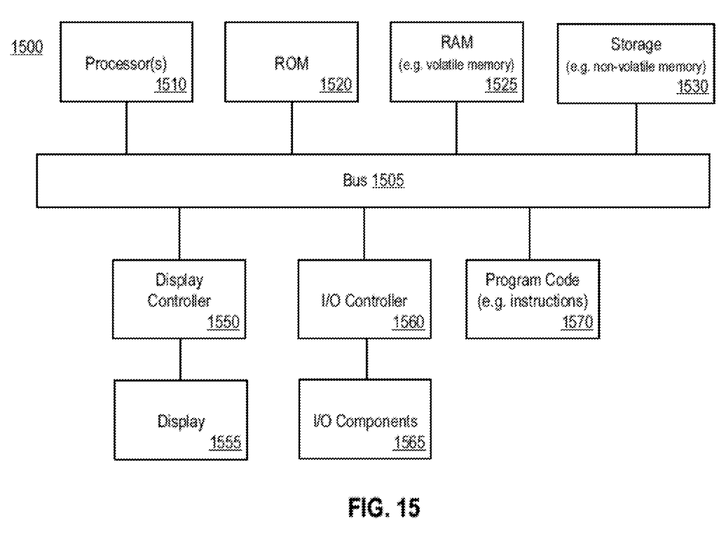

FIG. 15 shows a block diagram of an example of a system that may be used in conjunction with one or more embodiments of the disclosure. For example, system 1500 (or computing system, or server, or computing/electronic device, or device) may represent any of the devices or systems described herein that perform any of the processes, operations, or methods of the present disclosure. Note that while the computing system 1500 illustrates various components, it is not intended to represent any particular architecture or manner of interconnecting the components as such details are not germane to the present disclosure. It will also be appreciated that other types of systems that have fewer or more components than shown may also be used with the present disclosure.

As shown, the system 1500 may include a bus 1505 which may be coupled to a processor 1510, ROM (Read Only Memory) 1520, RAM (or volatile memory) 1525, and storage (or non-volatile memory) 1530. The processor(s) 1510 may retrieve stored instructions from one or more of the memories 1520, 1525, and 1530 and execute the instructions to perform processes, operations, or methods described herein. These memories represent examples of a non-transitory computer-readable medium (or machine-readable medium, a computer program product, etc.) containing instructions (or program code) which when executed by a processor (or system, device, etc.), cause the processor to perform operations, processes, or methods described herein.

As referred to herein, for example, with reference to the claims, a processor may include one or more processors. Moreover, the one or more processors 1510 may perform operations in an on-demand or “cloud computing” or “software-as-a-service” (SaaS) implementation. Accordingly, the performance of operations may be distributed among the one or more processors 1510, whether residing only within a single machine or deployed across a number of machines. For example, the one or more processors 1510 may be located in a single geographic location, or may be distributed across a number of geographic locations. The RAM 1525 may be implemented as, for example, dynamic RAM (DRAM), or other types of memory that require power continually in order to refresh or maintain the data in the memory. Storage 1530 may include, for example, magnetic, semiconductor, tape, optical, removable, non-removable, and other types of storage that maintain data even after power is removed from the system. It should be appreciated that storage 1530 may be remote from the system (e.g. accessible via a network).

A display controller 1550 may be coupled to the bus 1505 in order to receive display data to be displayed on a display device 1555, which can display any one of the user interface features or embodiments described herein and may be a local or a remote display device. The computing system 1500 may also include one or more input/output (I/O) components 1565 including mice, keyboards, touch screen, network interfaces, printers, speakers, and other devices. Typically, the input/output components 1565 are coupled to the system through an input/output controller 1560.

Program code 1570 may represent any of the instructions, applications, software, libraries, toolkits, modules, components, engines, units, functions, logic, etc. as described herein. Program code 1570 may reside, completely or at least partially, within the memories described herein (e.g. non-transitory computer-readable media), or within a processor during execution thereof by the computing system. Program code 1570 may include both machine code, such as produced by a compiler, and files containing higher-level or intermediate code that may be executed by a computing system or other data processing apparatus (or machine) using an interpreter. In addition, program code 1570 can be implemented as software, firmware, or functional circuitry within the computing system, or as combinations thereof. Program code 1570 may also be downloaded, in whole or in part, through the use of a software development kit or toolkit that enables the creation and implementation of the described embodiments.

Moreover, any of the disclosed embodiments may be embodied in various types of hardware, software, firmware, and combinations thereof. For example, some techniques disclosed herein may be implemented, at least in part, by non-transitory computer-readable media that include program instructions, state information, etc., for performing various methods and operations described herein. The computer-readable storage medium may be any tangible non-transitory medium such as optical (e.g., CD, DVD, Blu-Ray, etc.), magnetic, hard disk, volatile or non-volatile, solid state, or any other type of storage medium known in the art.

The terms “a”, “an” and “one” are defined herein to mean “at least one”, that is, these terms do not exclude a plural number of items, unless stated otherwise.

Terms such as “substantially”, “generally” and “about”, which modify a value, condition or characteristic of a feature of an exemplary embodiment, should be understood to mean that the value, condition or characteristic is defined within tolerances that are acceptable for the proper operation of this exemplary embodiment for its intended application.

Unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

Expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present description, the expression “based on” is intended to mean “based at least partly on”, unless specified otherwise (e.g. “based solely on”). More particularly, the expression “based on” could also be understood as meaning “depending on”, “representative of”, “indicative of”, “associated with” or similar expressions.

This inventive subject matter has been described in terms of specific embodiments, embodiments and configurations which are intended to be exemplary only. Persons of ordinary skill in the art will appreciate, having read this disclosure, that many obvious variations, modifications and refinements may be made without departing from the inventive concept(s) presented herein. The scope of the exclusive right sought by the Applicant(s) is therefore intended to be limited solely by the appended claims.

What is claimed is:

1. A method, comprising:
instantiating a digital infrastructure (D-Inf) corresponding to at least one real-world infrastructure, comprising instantiating digital representatives (D-Reps) corresponding to digital replicas of the real-world objects included in the at least one real-world infrastructure;
providing a communication plane for providing services to the D-Inf;
connecting the D-Inf to the real-world objects using the communication plane to collect real-world data defining states of the real-world objects, the D-Inf being connected to each real-world object via a respective D-Rep, each respective D-Rep being associated with the real-world data of the real-world object; and
simulating a behavior of the real-world objects via the D-Reps using a simulator accessible to the D-Inf instance using the communication plane.

2. The method of claim 1, wherein providing the communication plane includes providing a data exchange protocol between the D-Inf and its corresponding at least one real-world infrastructure and between the D-Inf and an external D-Inf.

3. The method of claim 1, wherein providing the services to the D-Inf include:
providing a data collection service for collecting the real-world data from the real-world objects and for associating the real-world data collected to the corresponding D-Reps;
providing a connection service for connecting the real-world objects to the corresponding D-Reps;
providing a hosting service for allocating data storage associated with the D-Reps; and
providing an analysis service for managing one or more analysis task performed on the real-world data associated with the D-Reps.

4. The method of claim 3, wherein providing the data collection service includes:
allocating resources for collecting the real-world data;
preparing missions for data collection, wherein each mission comprises steps for collecting and processing data from one or more sources; and
performing network-wide configurations for collecting the real-world data.

5. The method of claim 3, wherein providing the data collection service includes:
monitoring battery life of sensors used to collect the real-world data from the real-world objects;
adjusting pre-filtering settings of the real-world data collected based at least on the battery life of the sensors; and
monitoring real-world objects for new real-world data available.

6. The method of claim 3, wherein providing the connection service includes:
connecting the D-Reps of the D-Inf to each other to allow interaction between the D-Reps; and
connecting the D-Inf to external functions, external D-Reps or third-party services to allow for using external services.

7. The method of claim 3, wherein providing the connection service includes:
migrating the D-Reps from one server to another within the data storage based on mobility of the real-world objects;
setting-up connectivity tunnels for connection to external simulation environments; and
authenticating the D-Reps.

8. The method of claim 3, wherein providing the hosting service includes:
managing lifecycle of the D-Reps, including resource allocation and deallocation of the D-Reps; and
managing associations within the D-Inf.

9. The method of claim 3, wherein providing the analysis service includes:
determining connectivity requirements for performing the one or more analysis task;
performing resource management for computation and storage requirements for performing the one or more analysis tasks; and
providing access to libraries of the simulator.

10. The method of claim 3, wherein providing the services to the D-Inf further includes:
processing, with the data collection service, the real-world data collected from the real-world objects and associated with the corresponding D-Rep instances;
managing, using the connection service, services from other elements of the D-Inf;
managing, using the hosting service, privacy of the data storage selected for hosting the D-Rep instances; and
analyzing, using the analysis service, the real-world data collected using the simulator.

11. The method of claim 10, wherein providing the data collection service includes one or more of:
merging similar or non-urgent real-world data collected;
cleaning or reducing size of the real-world data collected;
discarding defective real-world data collected;
sampling redundant real-world data collected;
labeling or tunneling urgent real-world data collected; or
processing urgent real-world data collected by edge nodes of the platform.

12. The method of claim 10, wherein providing the connection service includes:
managing data collection missions and connection missions; and
in-network processing of the data, including distribution of processing algorithms.

13. The method of claim 10, wherein providing the hosting service includes:
selecting to instantiate the D-Inf and the D-Reps in a private or common data storage;
validating D-Rep health and measuring overall accuracy of the D-Reps;
managing anonymization and labelling of the real-world data collected prior to analysis; and
selecting data storage location based on a location of the real-world objects.

14. The method of claim 10, wherein providing the analysis service includes:
providing abstraction levels for the D-Reps;
labelling the real-world data collected and digital-world data;
anonymizing the real-world data collected; and
selecting and providing benchmark libraries to the simulator.

15. The method of claim 1, wherein providing the communication plane comprises providing a Control and Management (C/M) plane and a Data plane, each connecting to a data collection service, a connection service, a hosting service, and an analysis service.

16. The method of claim 2, further comprising providing interconnection interfaces for connecting together a data collection service, a connection service, a hosting service, and an analysis service.

17. An apparatus, comprising:
at least one processor; and
a memory storing instructions that are executable by the at least one processor, the instructions comprising instructions to:
instantiate a digital infrastructure (D-Inf) corresponding to a real-world infrastructure;
instantiate one or more digital representations (D-Reps) corresponding to digital replicas of real-world objects included in the real-world infrastructure;
provide a communication plane adapted to provide services to the D-Inf;
connect the D-Inf to the real-world objects using the communication plane to collect real-world data defining states of the real-world objects, the D-Inf being connected to each real-world object via a respective D-Rep, each respective D-Rep being associated with the real-world data of the real-world object; and
simulate the behavior of the real-world objects via the D-Rep instances using a simulator accessible to the D-Inf instance using the communication plane.

18. The apparatus of claim 17, wherein the communication plane comprises a Control and Management (C/M) plane bus for providing C/M services to the D-Reps instances, and a Data plane bus for providing data services to the D-Rep instances.

19. The apparatus of claim 17, wherein the instructions further comprise instructions to:
collect the real-world data from the real-world objects and to associate the real-world data collected to the corresponding D-Reps,
connect the real-world objects to the corresponding D-Reps;
allocate data storage associated with the D-Reps; and
manage one or more analysis task to perform on the D-Rep instances via the simulator.

20. A non-transitory computer-readable medium having computer-readable instructions stored thereon that, when executed by one or more processors, cause a device to:
instantiate a digital infrastructure (D-Inf) corresponding to at least one real-world infrastructure, comprising instantiating digital representatives (D-Reps) corresponding to digital replicas of the real-world objects included in the at least one real-world infrastructure;
provide a communication plane for providing services to the D-Inf;
connect the D-Inf to the real-world objects using the communication plane to collect real-world data defining states of the real-world objects, the D-Inf being connected to a real-world object via a respective D-Rep, each respective D-Rep being associated with the real-world data of the real-world object; and
simulate a behavior of the real-world objects via the D-Reps using a simulator accessible to the D-Inf instance using the communication plane.
